(19) United States
(12) Patent Application Publication
(10) Pub. No.: US 2025/0348896 A1
(43) Pub. Date: Nov. 13, 2025

(54) TECHNIQUES TO PREDICT INTERACTIONS UTILIZING HIDDEN MARKOV MODELS

(71) Applicant: Adobe Inc., San Jose, CA (US)

(72) Inventors: Wangqian Ju, Ames, IA (US); Hsin-Ya Lou, San Jose, CA (US); Tian Zhou, San Jose, CA (US); Yuting Chen, San Jose, CA (US)

(73) Assignee: Adobe Inc., San Jose, CA (US)

(21) Appl. No.: 18/662,025

(22) Filed: May 13, 2024

(51) Int. Cl. G06Q 30/0202; G06F 9/50; G06Q 30/0201

(52) U.S. Cl. CPC G06Q 30/0202; G06F 9/5027; G06Q 30/0206

(57) ABSTRACT

Embodiments include a method, apparatus, system and computer-readable medium for generating a set of input features based on user account data associated with a user account, generating a hidden Markov model based on the set of input features, generating a predicted subscription probability matrix comprising probability values representing potential account interactions between the user account a set of computing applications, modifying one or more probability values of the predicted subscription probability matrix to form a modified predicted subscription probability matrix, and determining a predicted account interaction metric for the user account based on the modified predicted subscription probability matrix. Other embodiments are described and claimed.

### BACKGROUND

Recent years have seen developments in hardware and software platforms managing access to computing applications. For example, many entities provide user account management software to manage user accounts associated with client applications via various subscriptions. When managing access and interactions by many user accounts in connection with many different computing applications, each of which can have different sets of possible permissions, determining when a given user account is likely to interact with a particular computing application can be an important and challenging aspect of managing hardware and software resources and availability. There is a need for accurately predicting account interactions with computing applications to ensure that sufficient server and network resources (e.g., computer memory, bandwidth) are available to handle processing loads associated with the use of the computing applications.

### SUMMARY

Embodiments are generally directed to artificial intelligence (AI) techniques for predicting account interactions between client computers and computing applications over a defined time period. Some embodiments are particularly directed to an account interaction prediction system implementing one or more machine learning (ML) models arranged to generate one or more predicted account interaction metrics. A non-limiting example of a suitable ML model comprises a hidden Markov model. The predicted account interaction metrics represent predicted account interactions between client computers and computing applications executing on one or more servers over a defined time period. In one embodiment, for example, a predicted account interaction metric represents a probability of a user to authorize activation, inactivation, or retention of one or more subscriptions, via a client computer, to one or more products or services provided by one or more computing applications based on the predicted account interaction metric.

In some embodiments, an account management system uses the predicted account interaction metric to calculate one or more key performance indicators (KPIs) for an entity that makes, uses, sells, or owns the product or services. In one embodiment, for example, a KPI comprises a financial KPI, such as a present value of future cash flows expected from the subscriptions over a defined time period. The AI techniques overcome certain limitations of conventional techniques by providing a more flexible and accurate measurement relative to other financial KPIs, such as annual recurring revenue (ARR), for example. The entity uses the improved financial KPI for operations such as monitoring budget spend, managing marketing campaigns, or measuring retention quality of customer cohorts.

Some embodiments utilize, among other ML models, one or more customized hidden Markov models. For example, the account interaction prediction system utilizes individualized user account data to generate individual-level hidden Markov models for predicting the user account interactions with computing applications. For instance, in some implementations, the disclosed systems utilize user account data of a user account to generate a set of hidden Markov model matrices, such as an initial hidden state probability matrix, a transition probability matrix, and an emission probability matrix for a customized hidden Markov model for the user account.

To illustrate, in some embodiments, the disclosed systems generate the matrices for the customized hidden Markov model utilizing one or more neural networks. For example, in some cases, the disclosed systems generate the initial hidden state probability matrix utilizing an initial state neural network, the transition probability matrix utilizing a transition neural network, and the emission probability matrix utilizing an emission neural network. Furthermore, in some embodiments, the disclosed systems utilize the generated matrices of the customized hidden Markov model to determine one or more predicted account interaction metrics for the user account indicating predicted future interactions of the user account with one or more computing applications for one or more time periods.

In some embodiments, the account interaction prediction module generates the hidden Markov model matrices, which comprise probability values corresponding to hidden states (which are unobservable) and/or outcome states (which are observable) of the hidden Markov model. For instance, the account interaction prediction module generates a transition matrix comprising transition probability values indicating probabilities of moving from one given hidden state to another given hidden state. As another example, the account interaction prediction module generates an emission matrix comprising emission probability values indicating probabilities of moving from one given hidden state to one given outcome state. By customizing the matrices of a hidden Markov model according to user account data of a specific user account, the account prediction system determines hidden states, transitions, and outcome states based on the specific characteristics of the user account.

In some embodiments, based on the predicted outcome states of the hidden Markov model, the account interaction prediction module determines one or more predicted account interaction metrics. For example, the account interaction prediction module predicts user account events, such as activation of a subscription (e.g., new activation or re-activation), deactivation of a subscription (e.g., terminating or churning), and/or retention of a subscription (e.g., maintaining) to a computing application. In some implementations, the account interaction prediction module determines predicted account interaction metrics in connection with multiple computing applications (e.g., multiple access events). In some embodiments, the account interaction prediction module determines predicted account interaction metrics corresponding to different time periods or time scales, such as account purchases or subscriptions beginning at different times and/or ending at different times.

In some embodiments, the account interaction prediction module determines predicted account interaction metrics corresponding to account purchases or subscriptions beginning at different times and/or ending at different times or time scales. One example of a predicted account interaction metric is referred to as a lifetime value (LTV) prediction or a customer lifetime value (CLTV) (collectively referred to as an LTV). An LTV is a metric that describes an expected monetary value a customer would bring to an entity (e.g., a business) in a given time window (e.g., over 1 year, 3 years, 5 years, etc.). The LTV is a customer-level metric as it is obtained by aggregating subscription-level results (e.g., individual subscriptions). A customer-level metric provides a higher-level of insight and accuracy relative to simply computing a monetary value of each individual paid subscription. For example, the LTV includes metrics representing activities of a subscriber, such as the subscriber initiating a new subscription, canceling a subscription, switching from a first subscription to a second subscription, converting from a trial subscription to a paid subscription, maintaining multiple subscriptions simultaneously, restarting a previous subscription, and other relevant metrics. The subscription-level information for a given customer is then aggregated to customer-level information. The LTV is an important metric for customer relationship management (CRM). It can be used to assist in monitoring budget spend, managing marketing campaigns, or measuring retention quality of customer cohorts. Paid LTV prediction refers to predicting the LTV of user accounts with active subscriptions (e.g., paid users).

Any of the above embodiments may be implemented as instructions stored on a non-transitory computer-readable storage medium and/or embodied as an apparatus with a memory and a processor configured to perform the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an account interaction prediction system in accordance with one embodiment.

FIG. 2 illustrates a matrix generation system in accordance with one embodiment.

FIG. 3 illustrates a subscription data structure in accordance with one embodiment.

FIG. 4 illustrates an observed subscription matrix in accordance with one embodiment.

FIG. 5 illustrates predicted subscription probability matrix in accordance with one embodiment.

FIG. 6 illustrates hidden Markov matrices in accordance with one embodiment.

FIG. 7 illustrates values for hidden Markov matrices in accordance with one embodiment.

FIG. 8 illustrates an example of a hidden Markov model in accordance with one embodiment.

FIG. 9 illustrates an example of a hidden Markov model in accordance with one embodiment.

FIG. 10 illustrates price mapper module in accordance with one embodiment.

FIG. 11 illustrates a transformer encoder module in accordance with one embodiment.

FIG. 12 illustrates a system in accordance with one embodiment.

FIG. 13 illustrates a logic flow in accordance with one embodiment.

FIG. 14 illustrates an apparatus in accordance with one embodiment.

FIG. 15 illustrates an artificial intelligence architecture in accordance with one embodiment.

FIG. 16 illustrates an artificial neural network in accordance with one embodiment.

FIG. 17 illustrates a computer-readable storage medium in accordance with one embodiment.

FIG. 18 illustrates a computing architecture in accordance with one embodiment.

FIG. 19 illustrates a communications architecture in accordance with one embodiment.

### DETAILED DESCRIPTION

Embodiments are generally directed to artificial intelligence (AI) techniques for predicting account interactions between client computers and computing applications over a defined time period. Some embodiments are particularly directed to an account interaction prediction system implementing one or more machine learning (ML) models arranged to generate one or more predicted account interaction metrics. A non-limiting example of a suitable ML model comprises a hidden Markov model. The predicted account interaction metrics represent predicted account interactions between client computers and computing applications executing on one or more servers over a defined time period. In one embodiment, for example, a predicted account interaction metric represents a probability of a user to authorize activation, inactivation, or retention of one or more subscriptions, via a client computer, to one or more products or services provided by one or more computing applications based on the predicted account interaction metric. An account management system uses the predicted account interaction metric to calculate one or more key performance indicators (KPIs) for an entity that makes, uses, sells, or owns the product or services. In one embodiment, for example, a KPI comprises a financial KPI, such as a present value of future cash flows expected from the subscriptions over a defined time period. The AI techniques overcome certain limitations of conventional techniques by providing a more flexible and accurate measurement relative to other financial KPIs, such as annual recurring revenue (ARR), for example. The entity uses the improved financial KPI for operations such as monitoring budget spend, managing marketing campaigns, or measuring retention quality of customer cohorts. Although exemplary embodiments are described in connection with a particular AI system, the principles described herein can also be applied to other types of AI systems as well. Embodiments are not limited in this context.

Conventional prediction systems attempt to predict account interactions with computing applications. Such conventional systems suffer from a number of technical deficiencies, including inflexibility by imposing rigid assumptions on the models that constrain the models to a small set of real-world applications, inaccuracy by generating imprecise predictions, and inefficiency by utilizing excessive data storage, memory, and computing resources. For instance, conventional systems inflexibly constrain their prediction models with rigid and unrealistic assumptions. For example, conventional systems often utilize sub-models to predict factors that influence user account interactions, thereby limiting prediction model robustness because of variability of account interactions. Additionally, conventional systems often cannot generate accurate predictions for time periods different from training dataset periods, thereby limiting prediction robustness for different time scales without training separate models for the different time scales. Further, conventional systems inaccurately generate predictions of account interactions. In particular, conventional systems often lack in-depth insight into the dynamics of account interactions with computing applications, thereby missing interactions and yielding incomplete predictions. For instance, conventional systems often generate predictions that do not account for variations such as interactions by user accounts with subsets of computing applications. Inaccurately generating predictions of account interactions with computing applications results in inaccurate determinations of hardware, software, and network resource requirements for handling user account interactions for the computing applications. In addition, conventional systems often require large datasets of historical data to generate meaningful predictions. For example, conventional systems often require years of historical account data to generate predictions of account interactions for future years, which can result in unreliable and outdated predictions given frequently inconsistent records maintained by entities. Processing such large amounts of data, conventional systems often expend excessive computing time and resources (e.g., memory, storage space, and processing bandwidth). By processing large amounts of historical data, conventional systems often require extensive user interactions to preprocess, clean, and maintain historical data from multiple legacy systems, which can also lead to data inaccuracies, outdated predictions, and unreliable results.

Embodiments of the present disclosure provide solve these and other challenges associated with managing user account interactions with computing applications by, at least in part, utilizing customized hidden Markov models. In some embodiments, the disclosed systems utilize individualized user account data to generate individual-level hidden Markov models for predicting the user account interactions with computing applications. For instance, in some implementations, the disclosed systems utilize user account data of a user account to generate a set of hidden Markov model matrices, such as an initial hidden state probability matrix, a transition probability matrix, and an emission probability matrix for a customized hidden Markov model for the user account. To illustrate, in some embodiments, the disclosed systems generate the matrices for the customized hidden Markov model utilizing one or more neural networks. For example, in some cases, the disclosed systems generate the initial hidden state probability matrix utilizing an initial state neural network, the transition probability matrix utilizing a transition neural network, and the emission probability matrix utilizing an emission neural network. Furthermore, in some embodiments, the disclosed systems utilize the generated matrices of the customized hidden Markov model to determine one or more predicted account interaction metrics for the user account indicating predicted future interactions of the user account with one or more computing applications for one or more time periods.

The account interaction prediction module generates the hidden Markov model matrices, which comprise probability values corresponding to hidden states (which are unobservable) and/or outcome states (which are observable) of the hidden Markov model. For instance, the account interaction prediction module generates a transition matrix comprising transition probability values indicating probabilities of moving from one given hidden state to another given hidden state. As another example, the account interaction prediction module generates an emission matrix comprising emission probability values indicating probabilities of moving from one given hidden state to one given outcome state. By customizing the matrices of a hidden Markov model according to user account data of a specific user account, the account prediction system determines hidden states, transitions, and outcome states based on the specific characteristics of the user account.

Based on the predicted outcome states of the hidden Markov model, the account interaction prediction module determines one or more predicted account interaction metrics. For example, the account interaction prediction module predicts user account events, such as activation of a subscription (e.g., new activation or re-activation), deactivation of a subscription (e.g., terminating or churning), and/or retention of a subscription (e.g., maintaining) to a computing application. In some implementations, the account interaction prediction module determines predicted account interaction metrics in connection with multiple computing applications (e.g., multiple access events). In some embodiments, the account interaction prediction module determines predicted account interaction metrics corresponding to different time periods or time scales, such as account purchases or subscriptions beginning at different times and/or ending at different times.

In some embodiments, the account interaction prediction module determines predicted account interaction metrics corresponding to account purchases or subscriptions beginning at different times and/or ending at different times or time scales. One example of a predicted account interaction metric is referred to as a lifetime value (LTV) prediction or a customer lifetime value (CLTV) (collectively referred to as an LTV). An LTV is a metric that describes an expected monetary value a customer would bring to an entity (e.g., a business) in a given time window (e.g., over 1 year, 3 years, 5 years, etc.). The LTV is a customer-level metric as it is obtained by aggregating subscription-level results (e.g., individual subscriptions). A customer-level metric provides a higher-level of insight and accuracy relative to simply computing a monetary value of each individual paid subscription. For example, the LTV includes metrics representing activities of a subscriber, such as the subscriber initiating a new subscription, canceling a subscription, switching from a first subscription to a second subscription, converting from a trial subscription to a paid subscription, maintaining multiple subscriptions simultaneously, restarting a previous subscription, and other relevant metrics. The subscription-level information for a given customer is then aggregated to customer-level information. The LTV is an important metric for customer relationship management (CRM). It can be used to assist in monitoring budget spend, managing marketing campaigns, or measuring retention quality of customer cohorts. Paid LTV prediction refers to predicting the LTV of user accounts with active subscriptions (e.g., paid users).

The account interaction prediction module provides a variety of benefits relative to conventional systems. For example, the account interaction prediction module can predict LTV based on user account data using the hidden Markov model for current and future subscriptions, considering such factors as a user account having multiple subscriptions, relationships between subscriptions, switching between subscriptions, conversion to new subscriptions, and other metrics. This is an advantage over conventional techniques that merely focus on subscription-level predictions. Subscription-level predictions assume that all subscriptions are independent. But one subscriber can have multiple paid subscriptions at the same time, indicating that the independence assumption might not necessarily hold. A subscription-level predictor is not able to capture the connections or relationships among different subscriptions. Further, a subscription-level predictor relies on a price map that is calculated by averaging revenues over historical data and is fixed for all users. However, different subscribers could have different price maps due to different user attributes. For instance, pricing of a same product varies across different regions or certain customers receive discounts which changes the pricing. In addition, conventional techniques use shorter-term metrics (e.g., 1 month) or longer-term metrics (e.g., 1 year) based on subscriber behavior to estimate longer-term metrics (e.g., 1-3 years) without factoring in changes to the subscriber behavior, leading to inaccurate estimates. In another example, embodiments implement a hidden Markov model architecture that is designed to better represent subscriber behavior based on features such as historical engagement data, attributes, subscription information, and short-term observed subscription status. As a result, the HMM model does not require long-term true LTV as labels in training but can infer long-term subscription probabilities once the dynamic can be described by the hidden Markov model matrices. Further, the HMM model implements techniques such as a price map representing a true short-term LTV to learn a model to predict prices for each subscriber from input features associated with a subscriber, an ensemble of multiple binary-classification HMM sub-models that share a same initial hidden states matrix and transition matrix, so that the dependence of different subscriptions can be captured, and/or a transformer encoder to perform flexible retention curve modeling to solve for changes in retention probability that may not necessarily fit an exponential decay curve.

As illustrated by the foregoing discussion, the present disclosure utilizes a variety of terms to describe features and advantages of the account interaction prediction module. Additional detail is now provided regarding the meaning of such terms. For example, as used herein, the term “user account” refers to an account or profile associated with a user of one or more computing applications. In particular, the term “user account” includes a user profile with information relating to a subscriber of the one or more computing applications. While this disclosure discusses various examples of a user account in terms of an account management system that manages use of computing applications, the systems disclosed herein are not limited to this example and can apply to any computer system that manages user accounts for any purposes.

As used herein, the term “user account data” refers to data or information about a user account. In particular, the term “user account data” includes identification data, user account profile data (e.g., demographic data or other attributes of a user of the user account), user account activity data, and user device activity data. To illustrate, user account data includes identifying information about a user of a computing application. For instance, user account data includes a name, email address, social media handle, or other unique identifying number or identifying information. Moreover, user account data includes account activity data, such as login activity associated with one or more computing applications, visits to the one or more computing applications, access history of a user account, support ticket metadata associated with a user account, and access data associated with the one or more computing applications. For example, user account data includes account activity such as access times and durations, access permissions, metadata of content accessed, opened, created, viewed, copied, modified, saved, downloaded, sent, and/or closed by the user account. User account data also includes device activity data, such as information identifying a client device associated with the user account. For instance, user account data includes user device activity data associated with the one or more computing applications, such as device access times and durations, and metadata of content accessed, opened, created, viewed, copied, modified, saved, downloaded, sent, and/or closed by the client device. Furthermore, user account data includes historical account interactions with the one or more computing applications.

As used herein, the term “computing application” refers to an application or software tool provided to a computing device. In particular, the term “computing application” includes a desktop application, a mobile application, and/or a web-based application. To illustrate, a computing application includes an application for document creation and editing, creative content creation and editing, and/or image and video editing.

As used herein, the terms “account interaction” or “account action” refer to an action performed by a user account or by a client device associated with the user account. In particular, the terms “account interaction” or “account action” include events and/or actions associated with one or more computing applications. To illustrate, an account interaction or account action includes logins for the one or more computing applications, access events by the user account or the client device to the one or more computing applications, and/or subscription statuses of the user account to the one or more computing applications.

As used herein, the term “hidden Markov model” (or “HMM”) refers to a model representing a Markov process. In particular, the term “hidden Markov model” includes customized (e.g., individual) hidden Markov models for user accounts. To illustrate, a hidden Markov model includes a model containing hidden states and outcome states. As used herein, the term “hidden state” refers to an unobservable state of the model, and the term “outcome state” refers to an observable state of the model. In particular, a hidden state is influenced by a previous hidden state, and an outcome state is influenced by a hidden state. For example, a hidden state indicates hidden dynamics of user account interactions with computing applications, while an outcome state indicates observable user account interactions.

As used herein, the term “initial state matrix” (or “initial hidden state probability matrix”) refers to a matrix of initial state values for a hidden Markov model. The term “initial state value” (or “initial state probability value”) refers to a metric of a probability that a user account exists at or within one hidden state of the HMM at a given time.

As used herein, the term “transition matrix” (or “transition probability matrix”) refers to a matrix of transition values for a hidden Markov model. The term “transition value” (or “transition probability value”) refers to a metric of a probability that a user account will transition from a first hidden state of the HMM to a second hidden state of the HMM (or, alternatively, remain at the one or more first hidden states), at a given time.

As used herein, the term “emission matrix” (or “emission probability matrix”) refers to a matrix of emission values for a hidden Markov model. The term “emission value” (or “emission probability value”) refers to a metric of a probability that a user account will emit one or more outcome states of the HMM based on having one hidden state of the HMM, at a given time.

As used herein, the term “predicted account interaction metric” refers to a metric indicating a probability of a particular account interaction occurring for a user account. In particular, the term “predicted account interaction metric” includes predictions that the user account will interact with one or more computing applications or that a specific activity occurs in connection with the user account and the one or more computing applications. To illustrate, a predicted account interaction metric includes, but is not limited to, a login, an access event, a change in access permissions, and/or a subscription to the one or more computing applications.

As used herein, the term “machine-learning model” refers to a computer representation that is tunable (e.g., trained) based on inputs to approximate unknown functions used for generating corresponding outputs. In particular, a machine-learning model includes a computer-implemented model that utilizes algorithms to learn from, and make predictions on, known data by analyzing the known data to learn to generate outputs that reflect patterns and attributes of the known data. For instance, a machine learning model includes, but is not limited to, a neural network, a decision tree (e.g., a gradient boosted decision tree), association rule learning, inductive logic programming, support vector learning, Bayesian network, regression-based model (e.g., censored regression), principal component analysis, or a combination thereof.

As used herein, the term “neural network” refers to a class of tunable (e.g., trainable) machine-learning models that comprise interconnected artificial neurons (e.g., organized in layers) that communicate and learn to approximate complex functions and generate outputs. In particular, the term “neural network” includes an algorithm (or set of algorithms) that implements deep learning techniques (e.g., a deep neural network) to model high-level abstractions in data. For example, a neural network includes a convolutional neural network, a recurrent neural network (e.g., an LSTM), a graph neural network, or a generative adversarial neural network. To illustrate, a neural network includes a deep neural network that processes user account data to generate values and/or parameters of a hidden Markov model. In particular, a neural network extracts embeddings from the user account data to generate values of the HMM matrices.

As used herein, the term “feature” refers to a metric, value, characteristic, or property of a user account. For instance, in some cases, a feature includes a user account characteristic input into a neural network. As used herein, the term “embedding” refers to a metric, value, or vector generated by a neural network, and representing a feature of a user account. For example, in some cases, an embedding includes an output of a neural network based on user account data. To illustrate, the neural network is trained with historical user account data (e.g., in the form of user account features) to extract embeddings that represent the user account in the form of a model, such as the hidden Markov model.

As used herein, the term “time period” refers to temporal information about an account interaction, such as a predicted account interaction. In particular, the term “time period” includes a period of time and/or a time scale. To illustrate, a time period includes a start time, an end time, and/or a duration of an account interaction. For example, a time period includes a length of time of a subscription of a user account to one or more computing applications. As another example, a time period includes a starting time and ending time of the subscription of the user account to the one or more computing applications.

Additional detail will now be provided in relation to illustrative figures portraying example embodiments and implementations of an account interaction prediction module.

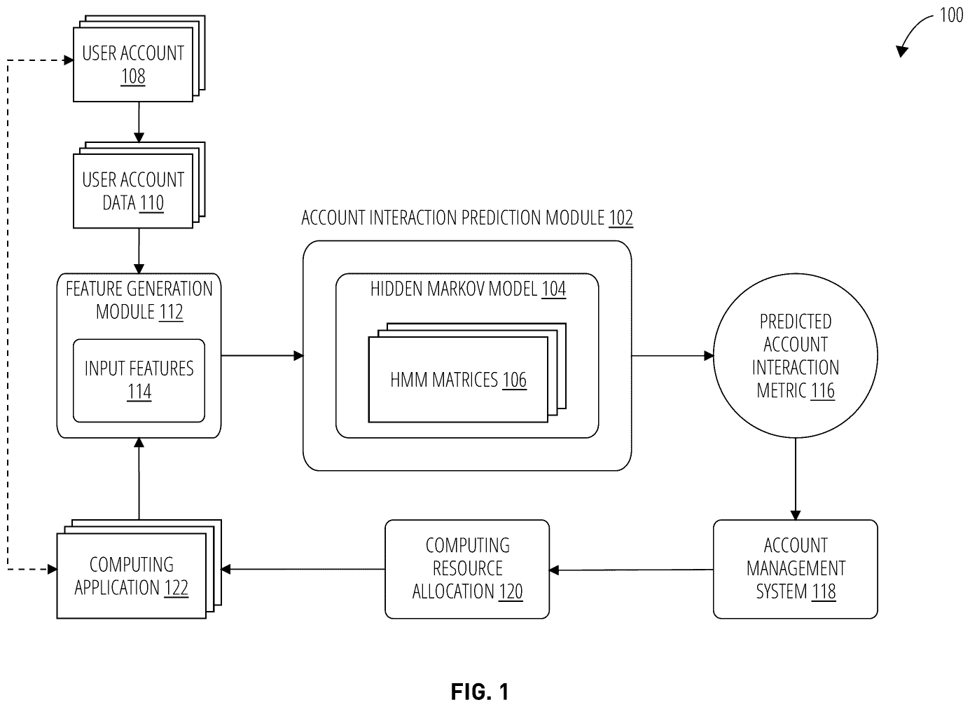

FIG. 1 illustrates an account interaction prediction system 100. The account interaction prediction system 100 comprises an example of an AI system (or environment) suitable for implementation by a computing device, such as a physical or virtual server device of a cloud-computing system, for example.

As depicted in FIG. 1, the account interaction prediction system 100 comprises, inter alia, an account interaction prediction module 102. In some instances, the account interaction prediction module 102 receives a request to determine a predicted account interaction metric 116. The request is received, for example, from a client device or an account management system 118. For example, the request includes an identification of a user account 108 and a query a current and predicted future interactions with one or more computing applications 122.

To illustrate, the account interaction prediction module 102 generates one or more hidden Markov model (HMM) matrices, such as HMM matrices 106 of a hidden Markov model 104 based on user account data 110 for the user account 108, and determines the predicted account interaction metric 116 based on the one or more HMM matrices 106. Some embodiments of a server device (not shown) are operated by a user to perform a variety of functions via the account management system 118 on the server device. For example, the server device, through the account interaction prediction module 102, on behalf of an account management system 118, performs functions such as, but not limited to, determining the user account data 110 associated with the one or more computing applications 122 for the user account 108, utilizing the user account data 110 to generate one or more HMM matrices 106 of a customized hidden Markov model for the user account 108, and determining predicted account interaction metrics 116 for the user account 108 via the customized hidden Markov model 104.

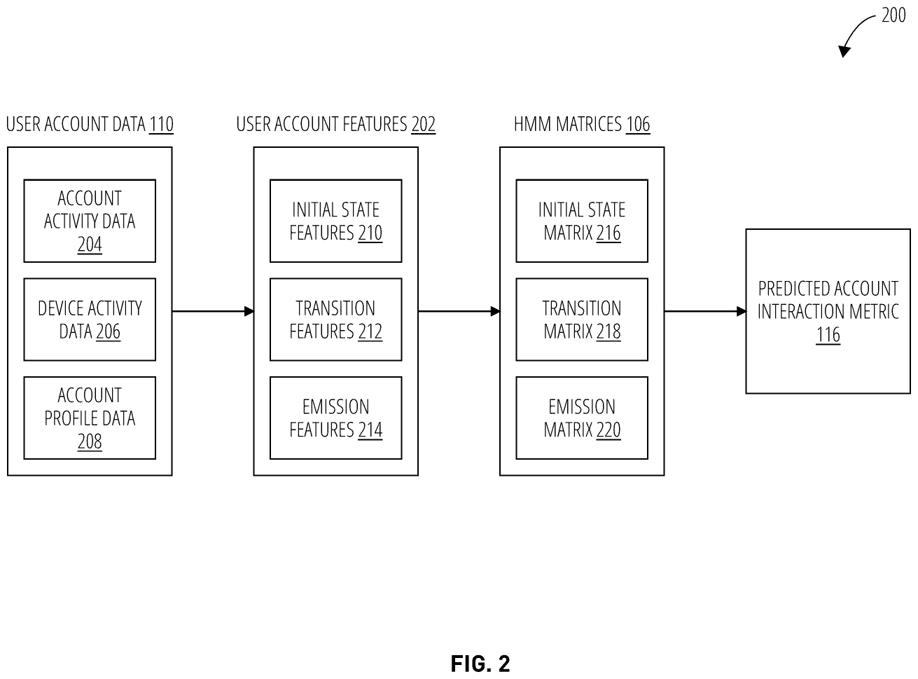

In one embodiment, for example, the account interaction prediction module 102 receives a set of input features 114. A feature generation module 112 may generate the input features 114 to include features from a user account 108, user account data 110 associated with the user account 108, and/or a set of computing applications 122 associated with the user account 108. For example, the input features 114 include historical engagement data such as desktop application usage, mobile application usage, web visits, and so forth. In another example, the input features 114 include user attributes such as country, signup source, age of subscription, and other demographic information. In yet another example, the input features 114 includes product attributes such as product names, promotion status for a subscription, entitlement period, and so forth. Additional examples of features are described with reference to FIG. 2. Embodiments are not limited to these examples.

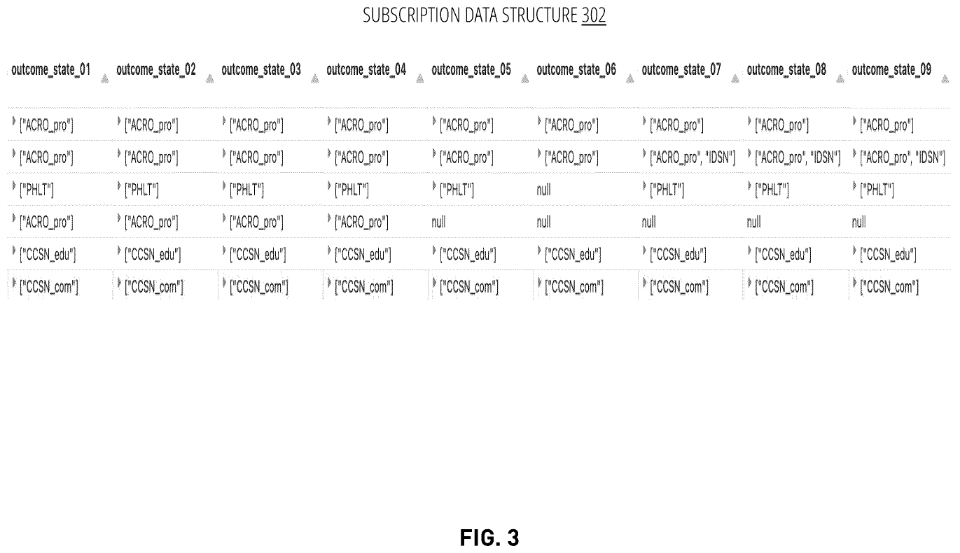

As discussed above, in some embodiments, the account interaction prediction module 102 determines one or more predicted account interaction metrics 116. Specifically, FIG. 3 shows the account interaction prediction module 102 identifying a user account 108, determining user account data 110 for the user account 108, generating a customized hidden Markov model 104 based on the user account data 110, and determining the predicted account interaction metric 116 utilizing the customized hidden Markov model 104.

As mentioned, in some implementations, the account interaction prediction module 102 identifies the user account 108. For instance, the account interaction prediction module 102 receives an indication of the user account 108 (e.g., from a client device), along with a request for the predicted account interaction metric 116 for the user account 108, such as from the account management system 118.

In some embodiments, the account interaction prediction module 102 determines the user account data 110 for the user account 108. For example, the account interaction prediction module 102 retrieves account profile data, account activity data, and/or device activity data for the user account 108 that indicates, among other things, past interactions with one or more computing applications 122. As explained in additional detail below, the account interaction prediction module 102 utilizes the user account data 110 to generate parameters of the customized hidden Markov model 104 that are specific to the user account 108.

In some implementations, the account interaction prediction module 102 generates the customized hidden Markov model 104 based on the user account data 110. For example, the account interaction prediction module 102 generates probability values for the customized hidden Markov model 104 associated with the user account 108. Examples of probability values include, without limitation, initial state values, transition values, and emission values, as described below.

In some implementations, the account interaction prediction module 102 determines the predicted account interaction metric 116 utilizing the customized hidden Markov model 104. For instance, the account interaction prediction module 102 samples outcome states of the customized hidden Markov model 104 to generate the predicted account interaction metric 116. The account management system 118 uses the predicted account interaction metric 116 to perform certain downstream actions. In one embodiment, for example, the account management system 118 sends a control directive for a computing resource allocation 120 to allocate a set of computing resources for the set of computing applications 122 based on the predicted account interaction metric 116.

In one or more embodiments, the account interaction prediction module 102 utilizes the customized hidden Markov model 104 to generate one or more predicted metrics indicating an estimated lifecycle of interactions of the user account 108 for one or more computing applications 122. For example, the account interaction prediction module 102 generates the predicted account interaction metric 116 to indicate an estimated state of the user account 108 with respect to the one or more computing applications 122. Examples of estimated state include, without limitation, a transition state, conversion state, termination state, activation state, deactivation state, churn state or other states associated with one or more subscriptions, account access, purchase of a product or service, or other account activity.

In some embodiments, the account interaction prediction module 102 utilizes the predicted account interaction metric 116 to determine an LTV value of the user account 108 in terms of transition, conversion and/or churn of one or more subscriptions, purchases, or account accesses to one or more computing applications 122. To illustrate, the account interaction prediction module 102 utilizes the estimated state of the user account 108 to determine whether the user account 108 has a first set of access permissions (e.g., a set of access permissions associated with an unpaid account), a second set of access permissions (e.g., a set of access permissions associated with a paid account), or other set of access permissions (e.g., one of a plurality of tiers of access permissions) for a computing application 122. In some embodiments, the account interaction prediction module 102 also determines the estimated lifecycle or LTV of interactions in connection with generating electronic messages to provide to a client device of the user account 108 for one or more computing applications 122.

In one embodiment, for example, the account interaction prediction module 102 generates a predicted account interaction metric 116 to determine an improved LTV value of a user account 108 in terms of transition, conversion and/or churn of one or more subscriptions, purchases, or account accesses to one or more computing applications 122. Calculating an LTV provides a more flexible measurement relative to conventional financial KPIs, such as annual recurring revenue (ARR), for example, as expressed in Equation (1) as follows:

$$LTV = {\sum }_{i = 1}^{36} {P}_{i} ( retention ) * {Monthly\_ARR}_{i} \qquad EQUATION ( 1 )$$

This is due, in part, to Equation (1) computing a subscription-level monetary value of each individual paid subscription, which under-estimates a total monetary value. By way of contrast, the account interaction prediction module 102 generates a predicted account interaction metric 116 that represents a customer-level monetary value that aggregates the individual paid subscriptions to determine a more precise total monetary value for a given customer. This approach directly computes a total monetary value of each paying customer by, at least in part, collecting subscriptions of a customer to acquire customer-level data, interpolating data for any gaps in the customer-level data, and providing better prediction results over a defined time period (e.g., predicting a 3-year LTV).

LTV represents a present value of future cash flows expected from the subscriber during their relationship with the company. In this way, it is a similar KPI as ARR. ARR determines a value that a customer will bring to a company in a defined time period (e.g., 12 months) if the company retains the customer for the defined time period. Similarly, LTV also a company to determine a value that a customer will bring to the company in a defined time period. However, it does not assume that the company will retain the customer for the defined time period (e.g., the next 12 months). Rather, it considers a retention rate. In that sense, LTV is a more flexible version of ARR. By way of example, an LTV prediction describes the expected monetary value a customer would bring to the business in a given window (like 1 year, 3 years . . . etc.). In one embodiment, for example, the account interaction prediction module 102 is arranged to calculate an LTV over a period of 36 months or 3 years. Further, the account interaction prediction module 102 is capable of predicting a 3-year LTV while using training data from a shorter time period, such as 1-year LTV training data. This solves a problem of attempting to calculate a 3-year LTV using the most recent 3-year LTV training data, which would necessarily include at least a 1-year LTV gap in the training data, thereby causing use of stale data.

Conventional techniques focus on estimating the lifespans of customers' existing subscriptions, which is subscription-level churn probability predictions. However, it has several limitations. For example, some subscriptions of paid users cannot be covered by conventional techniques. As a subscription-level predictor, conventional techniques focus on paid subscriptions. Paid users are the ones who have paid subscriptions on the scoring date. However, within the prediction window, a paid user could switch some of her paid subscriptions to other subscriptions or convert to other new subscriptions. In the cases of switch and new conversion, both new subscriptions are not even paid subscriptions on the scoring date, so they are not accessible to the current method, thus are not covered. In another example, subscription-level predictions assume that all subscriptions are independent. However, a single user can have multiple paid subscriptions at the same time, indicating that the independence assumption might not necessarily hold. As a subscription-level predictor, conventional techniques are not able to capture the connections or relationships among different subscriptions. In yet another example, after the churn probabilities (lifespans) are predicted, a price map holding revenues of different subscriptions is needed to convert them into LTV values. However, a price map is typically calculated by averaging revenues over historical data and is fixed for all users. But different users could have different price maps due to different user attributes. For instance, the pricing of the same product varies across different regions, or customers may get discounts which also changes the pricing. In still another example, conventional techniques make strong assumptions on customers' propensities. Since customers' lifespan estimation (e.g., churn probability prediction) does not need true LTV as labels, the model can be trained using data of short amount of time (e.g., one month for instance). But to use this one-month churn probability predictor to predict long-term lifespan, a large amount of users' propensities is assumed to stay the same during the prediction window.

The account interaction prediction module 102 addresses these and other challenges by predicting both short-term and long-term paid LTV on a customer level. The account interaction prediction module 102 uses a hidden Markov model 104 that utilizes a deep neural network framework to describe the dynamic nature of paid users' subscription behavior. The hidden Markov model 104 uses three HMM matrices 106 to describe the dynamic of a user's subscription behavior and the motivation behind such behavior. The HMM matrices 106 include an initial hidden state matrix, a transition matrix, and an emission matrix. A motivation behind users' subscription behavior is modeled by the hidden Markov model 104 hidden states and transition matrix. The subscription behavior is modeled by the hidden Markov model 104 outcome states and emission matrix. These three matrices are learned through such features as a users' historical engagement data, attributes, subscription information, and short-term observed subscription status. As a result, the hidden Markov model 104 does not require long-term true LTV as labels in training but can infer long-term subscription probabilities once the dynamic can be described by the HMM matrices 106.

To predict subscription probabilities of potentially multiple subscriptions of a given user, and consider price variation among user LTV, the account interaction prediction module 102 implements several modules to the hidden Markov model 104 framework, including a price mapping module, a multi-label classification module, and a transformer encoder module.

The price mapping module customizes pricing information for a specific user. Since different users might hold different product prices, the hidden Markov model 104 of the account interaction prediction module 102 utilizes a true short-term LTV to learn a model to predict prices for each user from the user's input features.

The multi-label classification module allows the hidden Markov model 104 to perform multi-label classification. On the customer level, users can have multiple subscriptions at the same time, revealing the multi-label classification nature of the task. This incurs a challenge because conventional techniques are used to solve multi-class classification problems. The multi-label classification module provides a solution for the multi-label problem to predict subscription probabilities of multiple subscriptions at the time. The hidden Markov model 104 framework is an ensemble of multiple binary-classification hidden Markov model sub-models. The multiple binary-classification hidden Markov model sub-models share the same initial hidden states matrix and transition matrix, so that the dependence of different subscriptions can be captured.

The transformer encoder module makes a retention curve more flexible. Conventional techniques attempt to fit an exponential decay curve in the case of retention probability. However, the actual change of retention probability may not be exponential decay. To make the fitted retention curve more flexible, the transformer encoder module implements a transformer encoder for the hidden Markov model 104. Although some embodiments use a transformer encoder, by way of example, it may be appreciated that other sub-models can also be implemented that make results from the hidden Markov model 104 more flexible and introduce more sources of loss. In one embodiment, for example, using a sub-model such as a transformer encoder and utilizing multi-loss optimization further improves model performance.

FIG. 2 illustrates the account interaction prediction module 102 generating HMM matrices 106 for the customized hidden Markov model 104 in accordance with one or more embodiments. Specifically, FIG. 2 shows the account interaction prediction module 102 determining user account data 110 for a user account 108, generating input features 114 for the user account 108, generating HMM matrices 106 for the user account 108, and generating the predicted account interaction metric 116.

For each user account 108, the account interaction prediction module 102 obtains user account data 110 including account activity data 204, device activity data 206, and/or account profile data 208. For instance, the account interaction prediction module 102 detects the account activity data 204, which indicates actions of the user account 108 in relation to the one or more computing applications 122. For example, in response to determining that the user account 108 has opened and used a first computing application 122, the account interaction prediction module 102 discerns such activity by the user account 108 in the account activity data 204. As another example, in response to determining that the user account 108 has previously subscribed (e.g., requested access permissions), but is no longer subscribing, to a second computing application 122, the account interaction prediction module 102 notes the subscription history associated with the second computing application 122.

Additionally, in some cases, the account interaction prediction module 102 detects the device activity data 206, which indicates actions of a user device (such as a client device) associated with the user account 108, in relation to the one or more computing applications 122. For example, the account interaction prediction module 102 detects device activity associated with the user account 108 in response to determining that a client device logged in to the user account 108. In additional embodiments, the account interaction prediction module 102 detects device activity in response to the client device opening and using the first computing application 122. Furthermore, the account interaction prediction module 102 also determines whether more than one client device associated with the user account 108 has accessed the first computing application 122.

Furthermore, in some embodiments, the account interaction prediction module 102 detects the account profile data 208, which indicates identifying information, demographic characteristics, and/or static attributes for the user account 108. For instance, in some implementations, the account interaction prediction module 102 determines a user account number, a user account setup date, a user account address, a user account email address, and/or a user account social media handle. Moreover, in some embodiments, the account interaction prediction module 102 determines demographic data associated with the user account 108, such as an age, gender, race, educational status, and/or geographic location of a user of the user account 108.

As mentioned, in some implementations, the account interaction prediction module 102 generates input features 114 for the user account 108 based on the user account data 110. To illustrate, the account interaction prediction module 102 generates a set of user account features 202 comprising, for example, initial state features 210, transition features 212, and/or emission features 214. For instance, the account interaction prediction module 102 analyzes the account activity data 204, the device activity data 206, and/or the account profile data 208 to determine characteristics of the user account 108 and convert the characteristics into a set of input features 114. To illustrate, the account interaction prediction module 102 converts the account activity data 204, the device activity data 206, and/or the account profile data 208 into numerical representations user account characteristics for processing through one or more neural networks, as described further below.

In particular, the account interaction prediction module 102 generates initial state features 210 that represent characteristics of the user account 108 associated with likelihoods that the user account 108 has one initial hidden state at a given time. Additionally, the account interaction prediction module 102 generates transition features 212 that represent characteristics of the user account 108 associated with likelihoods that the user account 108 will move from one particular hidden state to a different particular hidden state at a given time. Furthermore, the account interaction prediction module 102 generates emission features 214 that represent characteristics of the user account 108 associated with likelihoods that the user account 108 will emit one or more particular outcome states based on having one hidden state at a given time.

Based on the input features 114 for the user account 108, the account interaction prediction module 102 generates the HMM matrices 106. To illustrate, the account interaction prediction module 102 generates an initial state matrix 216, a transition matrix 218, and an emission matrix 220. For example, the account interaction prediction module 102 generates the initial state matrix 216 by generating elements of the initial state matrix 216 (e.g., initial state values) from the initial state features 210. Similarly, in some cases, the account interaction prediction module 102 generates the transition matrix 218 by generating elements of the transition matrix 218 (e.g., transition values) from the transition features 212. Additionally, in some embodiments, the account interaction prediction module 102 generates the emission matrix 220 by generating elements of the emission matrix 220 (e.g., emission values) from the emission features 214.

In some implementations, the account interaction prediction module 102 generates initial state probability values from the initial state features 210, indicating likelihoods that the user account 108 has an initial state of the customized hidden Markov model 104. The account interaction prediction module 102 populates the initial state matrix 216 from the initial state probability values. Similarly, in some implementations, the account interaction prediction module 102 generates transition probability values from the transition features 212, indicating likelihoods that the user account 108 will transition from one hidden state to another hidden state of the customized hidden Markov model 104. The account interaction prediction module 102 populates the transition matrix 218 from the transition probability values. Additionally, in some implementations, the account interaction prediction module 102 generates emission probability values from the emission features 214, indicating likelihoods that the user account 108 emits an outcome state from a hidden state of the customized hidden Markov model 104. The account interaction prediction module 102 populates the emission matrix 220 from the emission probability values.

The account interaction prediction module 102 utilizes the customized hidden Markov model 104 to generate the predicted account interaction metric 116. In particular, in some embodiments, the account interaction prediction module 102 utilizes the HMM matrices 106 to generate the predicted account interaction metric 116. For example, the account interaction prediction module 102 utilizes the initial state matrix 216, the transition matrix 218, and the emission matrix 220 to generate a vector of predicted outcome states for the user account 108 at one or more discrete points in time. As described further below, in some implementations, the account interaction prediction module 102 samples probabilities of user account 108 reaching the various hidden states and outcome states based on the probability values in the HMM matrices 106.

FIG. 3 illustrates a subscription data structure 302 to store information used by the account interaction prediction module 102. The information comprises a set of observed subscriptions to a set of products (e.g., applications on a client device) and/or services (e.g., Software As A Service (SaaS)) provided by the computing applications 122. The subscription data structure 302 is an example of user account data 110 for multiple user accounts 108 over a defined time period, which in this case is a 9-month period, that is suitable for use in generating a set of input features 114.

As depicted in subscription data structure 302, each row in the subscription data structure 302 corresponds to one user account 108 and each column corresponds to one month. For the rows, row 1 represents user account 1, row 2 represents user account 2, and so forth to row 6 representing user account 6. For the columns, column 1 is labeled as outcome_state_01 which represents month 1, column 2 is labeled as outcome_state_02 which represents month 2, and so forth to column 9 labeled as outcome_state_09 representing month 9.

The subscription data structure 302 illustrates examples of various user activity and scenarios that are modeled by the HMM matrices 106 of the hidden Markov model 104 using the user account data 110 for multiple user accounts 108. For row 1 representing user account 1 and columns 1 to 9 representing months 1 to 9, there is a set of 1 product that user account 1 subscribes to over time, including a product labeled “ACRO-pro” for months 1-9. For row 2 representing user account 2 and columns 1 to 9 representing months 1 to 9, there is a set of 2 products that user account 2 subscribes to over time, for different time periods, including the product ACRO-pro for months 1-9 and IDSN for months 7-9. This is an example of the user account 2 subscribed to multiple products for a subset of time period 1-9, namely months 7-9. For row 3 representing user account 3 and columns 1 to 9 representing months 1 to 9, there is a set of 1 product that user account 3 subscribes to over time, for different time intervals, including a product labeled “PHLT” for months 1-5 and 7-9, with no subscription for month 6. This is an example of the user account 3 terminating and restarting a same subscription within the defined time period. For row 4 representing user account 4 and columns 1 to 9 representing months 1 to 9, there is a set of 1 product that user account 4 subscribes to over time, including the product ACRO-pro for months 1-4. This is an example of the user account 4 terminating a subscription without starting a new subscription for a company. For rows 5 and 6 representing user accounts 5 and 6, respectively and columns 1 to 9 representing months 1 to 9, there is a set of 1 product that each of user account 5 and user account 6 subscribes to over time, including different versions of a product labeled “CCSN_edu” and “CCSN_com,” respectively, for months 1-9.

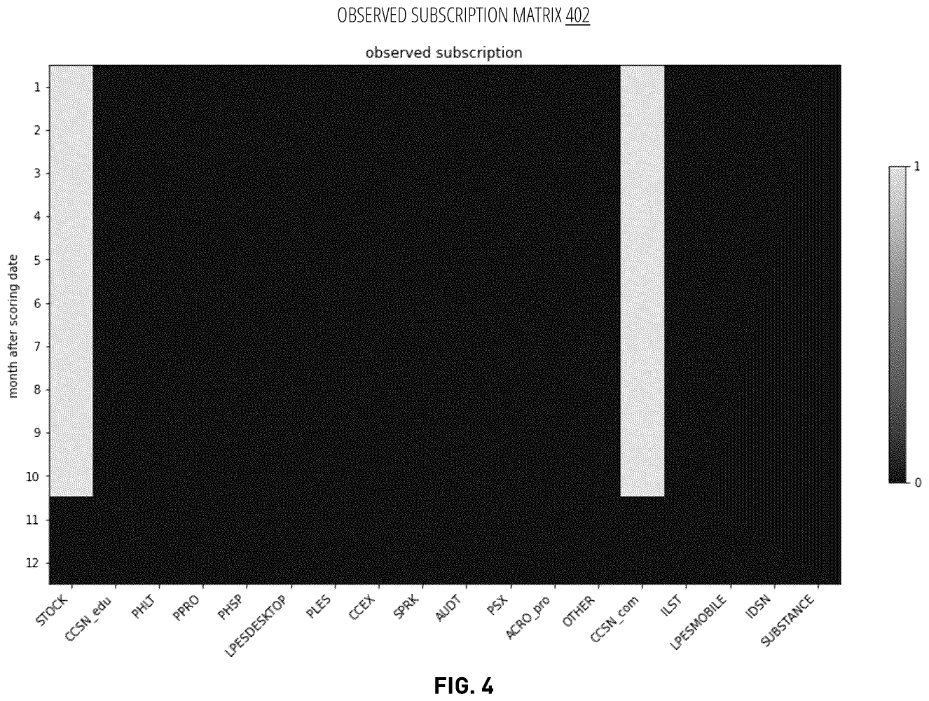

FIG. 4 illustrates an observed subscription matrix 402 comprising an example of observed subscriptions P for different products over a defined time period Q, where P and Q represent any positive integer. Specifically, the observed subscription matrix 402 is an example of a set of subscribed products offered by a computing application for a representative user account 108 based on a subscription data structure (e.g., subscription data structure 302) over a 12-month period (Q=12). The light gray area represents an active subscription (e.g., represented as a 1) and the black area represents an inactive subscription (e.g., represented as a 0). An observed subscription matrix 402 is generated for each user account 108 of the set of user accounts 108 based on the associated user account data 110. Each observed subscription matrix 402 may be part of the input features 114 for the hidden Markov model 104 of the account interaction prediction module 102.

In some embodiments, the observed subscription matrix 402 is generated by application of multi-hot encoding to the cells in a subscription data structure (e.g., subscription data structure 302) and concatenation of the results over 12 months for each user. As depicted in observed subscription matrix 402, each row represents one month, and each of the columns are the result of multi-hot encoding. On the x-axis, there are 18 product groups. For each group, a group name is assigned to a main product within each group, as presented on the x-axis. Note a product group may represent one or more types of products. Examples of group names include STOCK, Adobe® Creative Cloud® Individual, for education only (CCSN_edu), Adobe Photoshop® (PHSP), Adobe Photoshop Lightroom® Bundle (PHLT), and so forth. On the y-axis, there are 12 months after a scoring date. The observed subscription matrix 402 illustrates that a user account 108 has an active subscription to 2 products STOCK and CCSN_com over a 10-month subset (months 1-10) of the 12-month period, and for the final 2-month subset (months 11-12) of the 12-month period the user account 108 has an inactive subscription (e.g., unsubscribes) for both products (e.g., the user account 108 is churned).

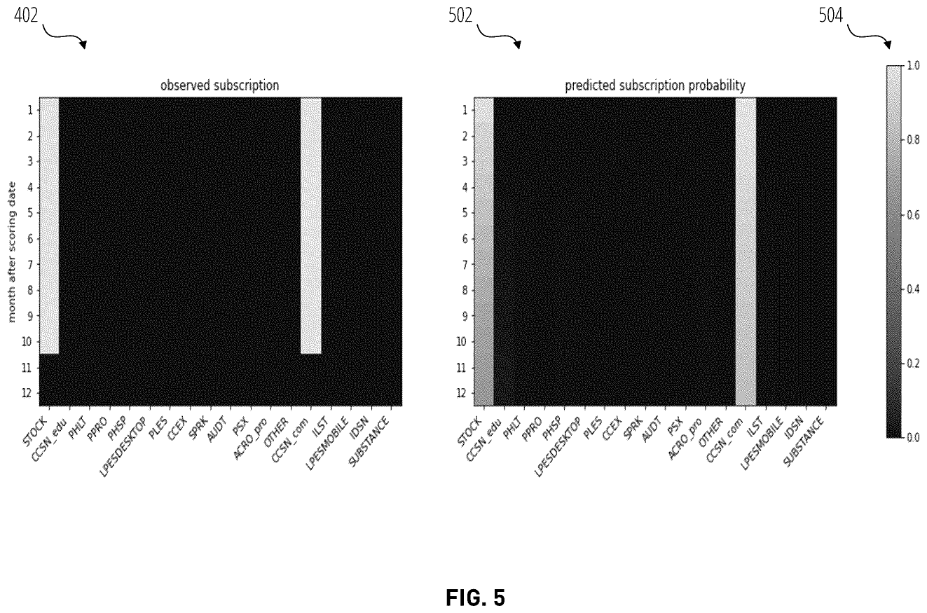

FIG. 5 illustrates a predicted subscription probability matrix 502 generated by the hidden Markov model 104 of the account interaction prediction module 102 based on the observed subscription matrix 402. The predicted subscription probability matrix 502 comprise s an example of training or inferencing operations of the account interaction prediction module 102. More particularly, the predicted subscription probability matrix 502 is one example of a predicted account interaction metric 116 generated by the HMM matrices 106 of the hidden Markov model 104 of the account interaction prediction module 102. Similar to the observed subscription matrix 402, the observed subscription matrix 402 covers a 12-month period.

FIG. 5 illustrates a predicted subscription probability matrix 502 generated by the hidden Markov model 104. This is the result when the 12 outcome states are concatenated vertically. For example, each cell of each column of the predicted subscription probability matrix 502 comprises a probability value representing a probability that the user account 108 will continue to subscribe to a product associated with the column, where the probability value falls within a gradient 504 represented by the color black at 0.0% probability to varying shades of lighter grey as the probability values approaches 100% probability. For example, column 1 of the observed subscription matrix 402 indicates an active subscription to the product labeled STOCK for a 10-month subset of the 12-month period. However, column 1 of the predicted subscription probability matrix 502 comprises probability values that indicate a decreasing probability of an active subscription over the same 12-month period. Similarly, column 14 of the observed subscription matrix 402 indicates an active subscription to the product labeled CCSN_com for a 10-month subset of the 12-month period. However, column 14 of the predicted subscription probability matrix 502 comprises probability values that indicate a slight decreasing probability of an active subscription over the same 12-month period.

It is worthy to note that the observed subscription matrix 402 is one of the model targets. This means that the hidden Markov model 104 may be trained, for example, using a binary cross-entropy as a loss function to compute a loss between the two matrices and then backpropagation is performed. This allows training of the hidden Markov model 104 using one year of data. In the case of churning, the predicted probabilities of the hidden Markov model 104 is gradually reduced over time, so the hidden Markov model 104 understands that the user account 108 is increasingly likely to churn. By relaxing restrictions on one or more of the HMM matrices 106, such as the emission matrix, the hidden Markov model 104 can make reasonable predictions and solve a problem of multiple-labels typically incurred by conventional techniques.

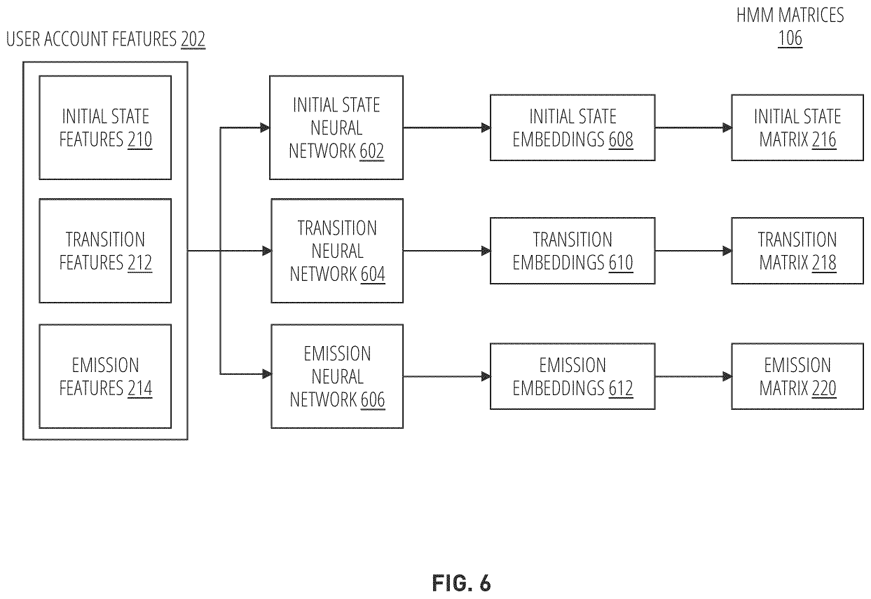

FIG. 6 illustrates the account interaction prediction module 102 generating HMM matrices 106 of the customized hidden Markov model 104 in accordance with one or more embodiments. Specifically, FIG. 6 shows the account interaction prediction module 102 processing the user account features 202 generated from the user account data 110 to determine the input features 114 for the user account 108 through an initial state neural network 602, a transition neural network 604, and an emission neural network 606 to generate embedding and matrices for the user account 108.

To illustrate, in some embodiments, the account interaction prediction module 102 processes the initial state features 210 from the user account features 202 through the initial state neural network 602 to generate initial state embeddings 608 and an initial state matrix 216. In some embodiments, the account interaction prediction module 102 generates the initial state embeddings 608 by processing the initial state features 210 through the initial state neural network 602. For example, the account interaction prediction module 102 utilizes the initial state neural network 602 to convert the initial state features 210 into a latent vector space that represents probability values of the user account 108 taking on a hidden state at a given time. For instance, the account interaction prediction module 102 utilizes the initial state neural network 602 to determine patterns in the initial state features 210 that resemble patterns from training data, and to generate the initial state embeddings 608 as outputs according to the training of the initial state neural network 602.

In some implementations, the account interaction prediction module 102 generates the initial state matrix 216 by utilizing the initial state neural network 602 to generate a plurality of initial state values from the initial state embeddings 608. For instance, the account interaction prediction module 102 generates initial state values and populates the initial state matrix 216 with the initial state values.

Furthermore, in some embodiments, the account interaction prediction module 102 processes the transition features 212 through the transition neural network 604 to generate transition embeddings 610 and a transition matrix 218. In some embodiments, the account interaction prediction module 102 generates the transition embeddings 610 by processing the transition features 212 through the transition neural network 604. For example, the account interaction prediction module 102 utilizes the transition neural network 604 to convert the transition features 212 into a latent vector space that represents probability values of the user account 108 transitioning from a hidden state to another hidden state, or could remain at the same hidden state, at a given time. For instance, the account interaction prediction module 102 utilizes the transition neural network 604 to determine patterns in the transition features 212 that resemble patterns from training data, and to generate the transition embeddings 610 as outputs according to the training of the transition neural network 604.

In some implementations, the account interaction prediction module 102 generates the transition matrix 218 by utilizing the transition neural network 604 to generate a plurality of transition values from the transition embeddings 610. For instance, the account interaction prediction module 102 generates transition values and populates the transition matrix 218 with the transition values.

Additionally, in some embodiments, the account interaction prediction module 102 processes the emission features 214 through the emission neural network 606 to generate emission embeddings 612 and an emission matrix 220. In some embodiments, the account interaction prediction module 102 generates the emission embeddings 612 by processing the emission features 214 through the emission neural network 606. For example, the account interaction prediction module 102 utilizes the emission neural network 606 to convert the emission features 214 into a latent vector space that represents probability values of the user account 108 emitting one or more outcome states from one or more hidden states. For instance, the account interaction prediction module 102 utilizes the emission neural network 606 to determine patterns in the emission features 214 that resemble patterns from training data, and to generate the emission embeddings 612 as outputs according to the training of the emission neural network 606.

Furthermore, in some implementations, the account interaction prediction module 102 generates the emission matrix 220 by utilizing the emission neural network 606 to generate a plurality of emission values from the emission embeddings 612. For instance, the account interaction prediction module 102 generates emission values and populates the emission matrix 220 with the emission values.

As mentioned, in some embodiments, the account interaction prediction module 102 generates a plurality of individualized hidden Markov models 104 for a plurality of user accounts 108. For instance, the account interaction prediction module 102 generates customized HMM matrices 106 of a first hidden Markov model 104 for a first user account 108, and customized HMM matrices 106 of a second hidden Markov model 104 for a second user account 108, in accordance with one or more embodiments. In some embodiments, the account interaction prediction module 102 generates a customized hidden Markov model 104 for a group of user accounts 108 sharing similar features. For instance, the account interaction prediction module 102 generates a set of HMM matrices 106 customized to a plurality of user accounts 108 that share a characteristic (e.g., a group of user accounts 108 having the same account actions in relation to a computing application 122).

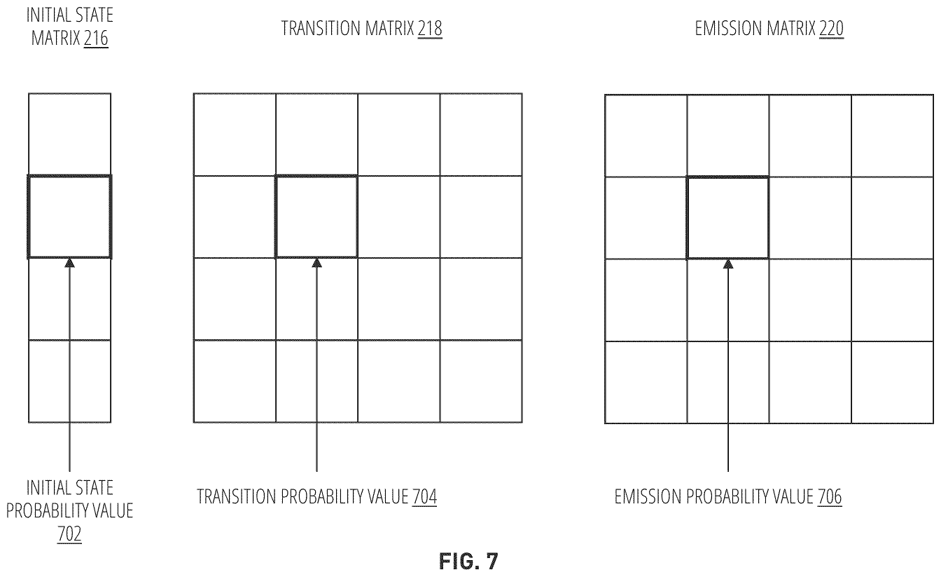

FIG. 7 illustrates the account interaction prediction module 102 populating the HMM matrices 106 with probability values in accordance with one or more embodiments. Specifically, FIG. 7 shows an example of an initial state matrix 216, a transition matrix 218, and an emission matrix 220.

In particular, FIG. 7 shows an element of the initial state matrix 216 comprising an initial state probability value 702. In some cases, the initial state probability value 702 corresponds to a hidden state of a hidden Markov model 104 for a user account 108 at a given time. To illustrate, the initial state probability value 702 indicates a likelihood that the user account 108 is initially in a particular initial hidden state of the hidden Markov model 104. For instance, the initial state probability value 702 indicates the probability of the user account 108 corresponding to the particular initial hidden state based on the past interactions of the user account 108 with respect to one or more computing applications 122. The initial state matrix 216 comprises a plurality of initial state values corresponding to a plurality of hidden states of the hidden Markov model 104 for the user account 108.

Relatedly, FIG. 7 shows an element of the transition matrix 218 comprising a transition probability value 704. In some cases, the transition probability value 704 corresponds to one or more hidden states of the hidden Markov model 104 for the user account 108. To illustrate, the transition probability value 704 indicates a likelihood that the user account 108 will transition from a first hidden state of the hidden Markov model 104 to a second hidden state of the hidden Markov model 104 or will remain at the first hidden state. The transition matrix 218 comprises a plurality of transition values corresponding to a plurality of hidden states of the hidden Markov model 104 for the user account 108.

Additionally, FIG. 7 shows an element of the emission matrix 220 comprising an emission probability value 706. In some cases, the emission probability value 706 corresponds to one or more hidden states of the hidden Markov model 104 for the user account 108. To illustrate, the emission probability value 706 indicates a likelihood that the user account 108 will emit one or more output states from a hidden state of the hidden Markov model 104. By way of contrast, a conventional HMM will only emit one output state at a time. The emission matrix 220 comprises a plurality of emission values corresponding to a plurality of hidden states of the hidden Markov model 104 for the user account 108.

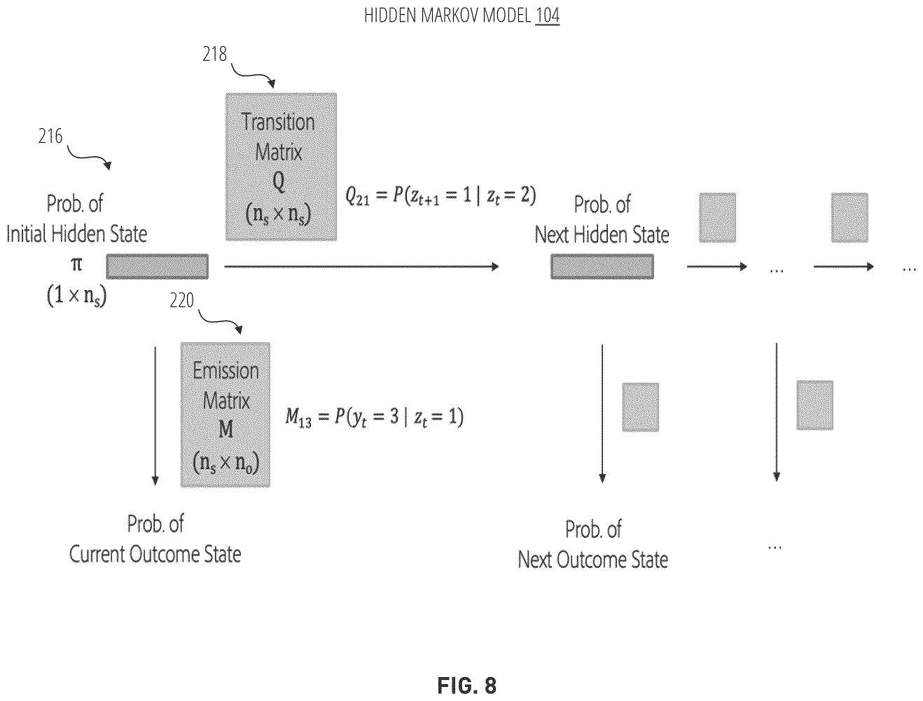

FIG. 8 illustrates an example of a hidden Markov model 104 suitable for use with the account interaction prediction module 102 in accordance with one or more embodiments.

In general, a hidden Markov model 104 is a statistical model that represents a system assumed to be a Markov process with unobserved (hidden) states. The hidden Markov model 104 is widely used in various areas such as natural language processing, speech recognition, bioinformatics, and finance, among others. The model is “hidden” because the state of the system is not directly visible to the observer. Instead, only output generated by the state can be observed. The “Markov” aspect of the model refers to the assumption that the future state of the process depends only on the current state, not on the sequence of events that preceded it. The power of the hidden Markov model 104 lies in its ability to model the probabilistic relationship between a sequence of observed events and a sequence of internal states that are not directly observable. By doing so, the hidden Markov model 104 can be used to predict future observations, infer the most likely sequence of hidden states that led to a given sequence of observations (decoding), and learn the model parameters that best fit the observed data (learning).

With respect to LTV, the observed output comprises subscriber and/or subscription information captured by the user account data 110. In this case, the hidden states are motivations of a subscriber which cannot be observed. The motivation could change or develop over time, and at each time step, the observed subscription behavior is affected by the subscriber motivations. This aligns to the concept of the hidden Markov model 104, where unobservable hidden states can change and develop over time as a Markov process, and observable outcome states are influenced by the hidden states. To calculate an LTV for a subscriber associated with a user account 108, the observable outcome states include a set of subscribed products of the subscriber, and the unobservable hidden states include psychological states, financial states, and/or behavioral states of subscribers. Those are the things that cannot be observed, and yet can change and develop over time to influence subscription behaviors of subscribers.

The hidden Markov model 104 assumes a next hidden state is influenced by, and only by, a current hidden state. This is also a property of the Markov process. The hidden Markov model 104 further assumes that a current outcome state is influenced by, and only by, current hidden states. Based on these two assumptions, the hidden Markov model 104 uses three HMM matrices 106, including an initial state matrix 216, a transition matrix 218, and an emission matrix 220, which are denoted as matrices π, Q, and M, respectively.

FIG. 8 illustrates the process of calculating probabilities of outcome states. The initial state matrix π gives probabilities of the initial hidden states. The transition matrix Q gives probabilities of a next hidden states given the current hidden states. The emission matrix M gives probabilities of the outcome states given the hidden states.

Specifically, the account interaction prediction module 102 determines a number of hidden states nₛ based on assumptions of characteristics of the user account 108. In one embodiment, all user accounts 108 have a same number of hidden states regardless of their characteristics. A number of hidden states could be manually adjusted. However, the model would need to be retrained with the new adjusted number of hidden states. The account interaction prediction module 102 also determines a number of outcome states no based on observations of user account data 110 of the user account 108 for the hidden Markov model 104. For instance, the account interaction prediction module 102 generates an initial state matrix 216 denoted as π having a dimension 1×nₛ. The account interaction prediction module 102 populates the initial state matrix 216 (π) with initial state probability values such as the initial state probability value 702. For example, the account interaction prediction module 102 assigns an element π₁ of the initial state matrix π with a probability of assuming a first hidden state: π₁=P(zₜ=z₁). Additionally, the account interaction prediction module 102 generates a transition matrix 218 denoted as Q having a dimension nₛ×nₛ. The account interaction prediction module 102 populates the transition matrix Q with transition probability values such as the transition probability value 704. For example, the account interaction prediction module 102 assigns an element q₂₁ of the transition matrix Q with a probability of transitioning from a second hidden state to a first hidden state: q₂₁=P(zₜ₊₁=1|zₜ=2). In terms of time, the transition does not need to be from the first hidden state to the second hidden state, but could also be from the second hidden state to a third hidden state, and so on. Furthermore, the account interaction prediction module 102 generates an emission matrix 220 denoted as M having dimension nₛ×nₒ. The account interaction prediction module 102 populates the emission matrix M with emission probability values such as the emission probability value 706. For example, the account interaction prediction module 102 assigns an element m₁₃ of the emission matrix M with a probability of emitting a third outcome state given a first hidden state: m₁₃=P(yₜ=3|zₜ=1) It does not necessarily need to be emitting the first outcome state from the first hidden state.

The account interaction prediction module 102 generates outcome states at any given time step t using the values for π, Q, and M using the following formula: outcome(t)=πQ^{t+-1}M; where probabilities of products in month t is (1×n₀) and a predicted lifespan in a 1-year subscription period is:

$${\sum }_{t = 1}^{12} outcome ( t ) .$$

Note the probability should be between 0 and 1 but the predicted lifespan could be larger than 1. Using this formula, the account interaction prediction module 102 calculates outcome (1), outcome (2), all the way to outcome (12). The outcome (1) is the outcome states of the first month. Then the account interaction prediction module 102 concatenates outcome (1) to outcome (12) vertically. This results in (12, number of outcomes) matrix that gives a 1-year predicted subscription probability matrix 502.

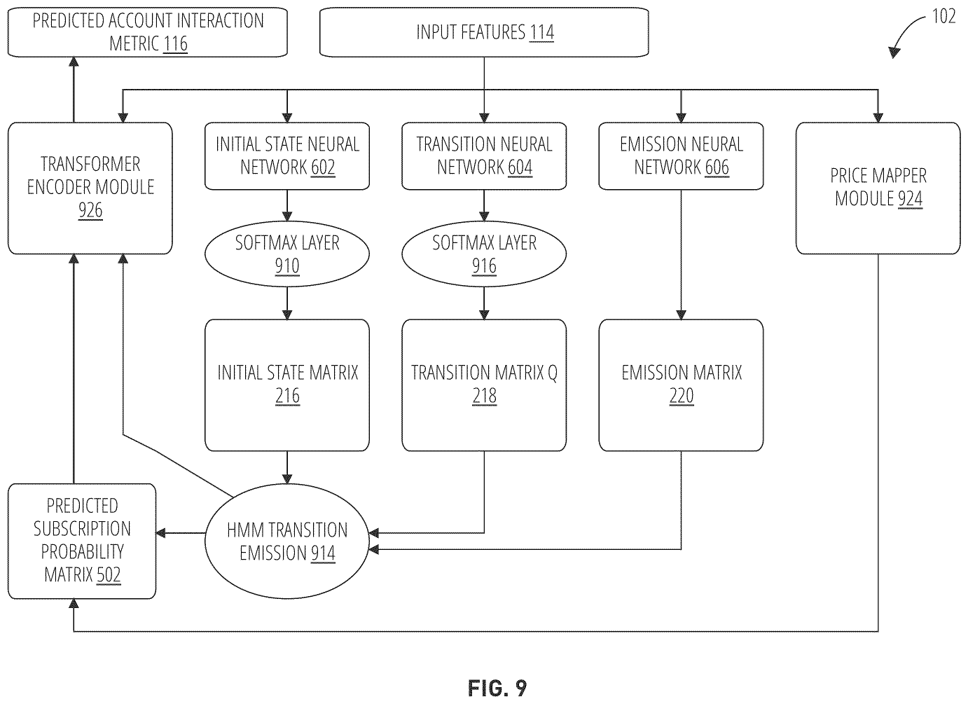

Different users as represented by the user accounts 108 should have different sets of π, Q, and M. As previously discussed, the account interaction prediction module 102 can determine the HMM matrices 106 (e.g., π, Q, and M matrices) of any given user account 108 from associated user account data 110. Further, the account interaction prediction module 102 implements the HMM matrices 106 as a multi-label solution. This is different from conventional techniques that attempt to generate HMM matrices 106 as a multi-class solution, where the outcome states are assumed to be mutually exclusive. For example, conventional systems utilize a SoftMax function prior to generating an emission matrix 220. The use of a SoftMax function allows only one outcome to be realized in order to solve a multi-class problem. However, for a customer level LTV, users can have multiple subscriptions to computing applications 122 at the same time. Therefore, the account interaction prediction module 102 is designed to solve a multi-label problem by removing the SoftMax function and relaxing restrictions on the emission matrix 220. As a result, the account interaction prediction module 102 allows every cell of the emission matrix 220 to be a proper probability value, as previously described with reference to the predicted subscription probability matrix 502. An example architecture for the account interaction prediction module 102 suitable for predicting an LTV for a user account 108 is further described with reference to FIG. 9.

FIG. 9 illustrates an example architecture for the account interaction prediction module 102 utilizing a hidden Markov model 104 in accordance with one or more embodiments. Specifically, the account interaction prediction module 102 implements a multi-label hidden Markov model 104 that is suitable for predicting an LTV for a user account 108 using associated user account data 110 and a set of customized HMM matrices 106 for the user account 108. In one embodiment, for example, the account interaction prediction module 102 may implement a formula for calculating LTV based on outcome state probabilities and predicted prices, as shown in Equation (2) as follows:

$$E [ {LTV}_{T} \vert X ] = {\sum }_{t = 1}^{T} {\sum }_{p = 1}^{P} {price}_{p} ( X ) \cdot {outcome}_{p} ( t \vert X ) \qquad EQUATION ( 2 )$$

As depicted in FIG. 9, the account interaction prediction module 102 receives as input a set of input features 114 generated from user account data 110 of a user account 108, and it outputs a predicted account interaction metric 116 based on the input features 114. The account interaction prediction module 102 passes the input features 114 through an initial state neural network 602, a transition neural network 604, and an emission neural network 606. The initial state neural network 602 generates a set of values and passes them through a SoftMax layer 910 to generate an initial state matrix 216 of dimension (1, n_state). The transition neural network 604 generates a set of values and passes them through a SoftMax layer 916 to generate a transition matrix 218 of dimension (n_state, n_state). The emission neural network 606 generates a set of values and uses the values to generate an emission matrix 220 of dimension (n_state, n_outcome). Note the output of the emission neural network 606 is not passed through a SoftMax function, thereby allowing every cell of the emission matrix 220 to be a proper probability value.

The account interaction prediction module 102 uses the probability values of the HMM matrices 106 comprising initial state matrix 216, transition matrix 218, and emission matrix 220, to generate an HMM transition emission 914 of n_steps. The HMM transition emission 914 is input to a transformer encoder module 926.

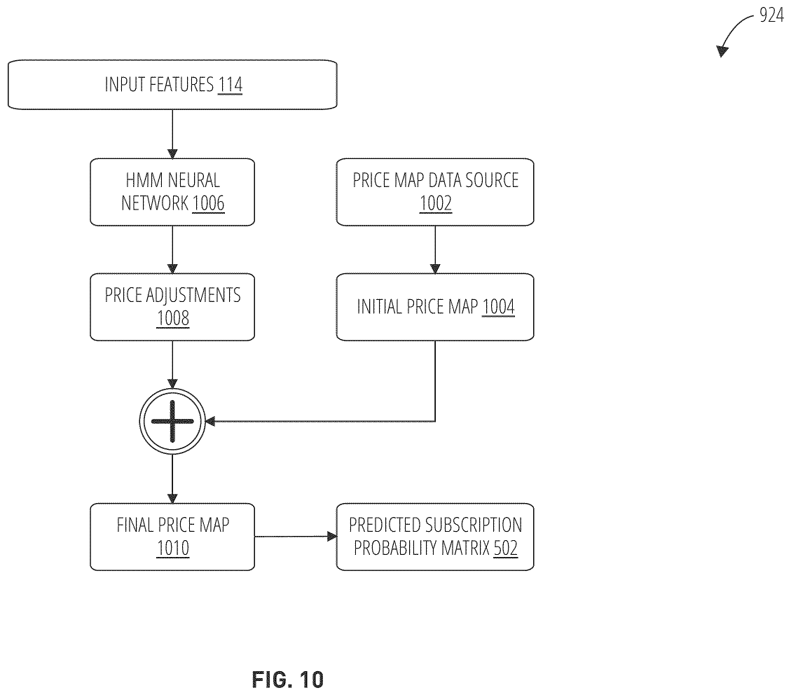

In addition, the account interaction prediction module 102 passes the input features 114 to a price mapper module 924. The account interaction prediction module 102 uses the price mapper module 924 to convert predicted probabilities into LTV values for the user account 108. To convert the probabilities into LTV values, the account interaction prediction module 102 utilizes a dynamic price map for subscribed products that is customized for a given user account 108 using the user account data 110 for the user account 108. This provides an advantage over conventional systems that use a fixed price map for all users, and therefore fails to account for variations between different users. For example, pricing for a user could be different across different regions or areas, different users might be offered different promotions, and other variations. To accommodate such variations, the price mapper module 924 generates a unique and reliable price map for each user account 108 based on the user's input features 114. The price mapper module 924 receives as input the input features 114, and it outputs a final price map customized for the user account 108 to a set of predicted subscription probability matrix 502 as described with reference to FIG. 5. The price mapper module 924 is described in further detail with reference to FIG. 10.

The predicted subscription probability matrix 502 is a matrix of dimension (n_step, n_outcome). The account interaction prediction module 102 generates the predicted subscription probability matrix 502 using values from the HMM transition emission 914. Note the price mapper module 924 uses the final price map to calculate LTV and it is passed to a loss function for model training. The account interaction prediction module 102 passes values from the predicted subscription probability matrix 502 as input to the transformer encoder module 926.

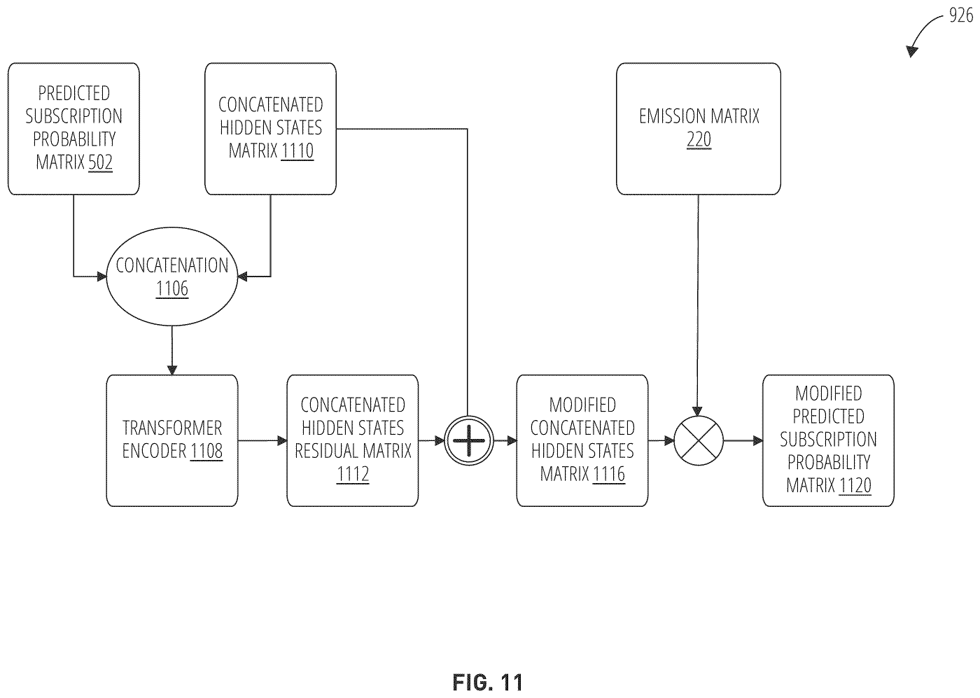

Furthermore, the account interaction prediction module 102 passes the input features 114 to a transformer encoder module 926. The transformer encoder module 926 is designed to introduce additional sources of loss, and therefore improve a stability of predicted results. The transformer encoder module 926 operates using “concatenated hidden states.” The concatenated hidden states is the concatenation results of all π's generated by the hidden Markov model 104. The transformer encoder module 926 then horizontally concatenates the predicted subscription probability matrix 502 and the concatenated hidden states matrix to obtain an input of the transformer encoder module 926. The transformer encoder module 926 is described in more detail with reference to FIG. 11.

FIG. 10 illustrates an example architecture for a price mapper module 924 of the account interaction prediction module 102 in accordance with one or more embodiments.

As previously described with reference to FIG. 9, the account interaction prediction module 102 passes the input features 114 to a price mapper module 924. The account interaction prediction module 102 uses the price mapper module 924 to convert predicted probabilities into LTV values for the user account 108. To convert the probabilities into LTV values, the account interaction prediction module 102 utilizes a dynamic price map for subscribed products that is customized for a given user account 108 using the user account data 110 for the user account 108. The price mapper module 924 generates a unique and reliable price map for each user account 108 based on a given set of input features 114.

As depicted in FIG. 10, the price mapper module 924 comprises an HMM neural network 1006 that receives the input features 114. The HMM neural network 1006 generates a set of price adjustments 1008 for product pricing based on the input features 114. The price mapper module 924 uses the price adjustments 1008 to adjust product pricing from an initial price map 1004 generated from a price map data source 1002. For example, the price map data source 1002 may comprise a database of observed product pricing over a defined interval, and the initial price map 1004 may comprise an average value of product prices derived from the database information. The price mapper module 924 adjusts the initial price map 1004 using the price adjustments 1008 from the HMM neural network 1006 that customizes the price adjustments 1008 based on the input features 114 from user account data 110 associated with a user account 108 to form a final price map 1010. The final price map 1010 and the predicted subscription probability matrix 502 are used to calculate a predicted LTV and are used as input to a loss function for model training.

FIG. 11 illustrates an example architecture for a transformer encoder module 926 of the account interaction prediction module 102 in accordance with one or more embodiments.

As previously described with reference to FIG. 9, the account interaction prediction module 102 passes the input features 114 to a transformer encoder module 926. The transformer encoder module 926 is designed to introduce additional sources of loss, and therefore improve a stability of predicted results.

As depicted in FIG. 11, the transformer encoder module 926 operates using a concatenated hidden states matrix 1110 of dimension (n_step, n_state). The concatenated hidden states matrix 1110 is the concatenation results of all π's generated by the hidden Markov model 104. The transformer encoder module 926 then performs horizontal concatenation 1106 of the predicted subscription probability matrix 502 and the concatenated hidden states emission matrix 220 to obtain an input for a transformer encoder 1108. The output of the transformer encoder 1108 is concatenated hidden states residual matrix 1112 of dimension (n_step, n_state). The concatenated hidden states residual matrix 1112 is added onto the concatenated hidden states matrix 1110 to generate a modified version of the concatenated hidden state matrix, referred to as a modified concatenated hidden states matrix 1116 of dimension (n_step, n_state). The modified concatenated hidden states matrix 1116 is then multiplied with the emission matrix 220 to generate a modified version of the predicted subscription probability matrix 502 referred to as a modified predicted subscription probability matrix 1120 of dimension (n_step, n_outcome). In this way, the account interaction prediction module 102 slightly modifies the results of the hidden Markov model 104, so that the prediction results can be more flexible and capable of adapting to different situations, use cases, and user accounts 108.

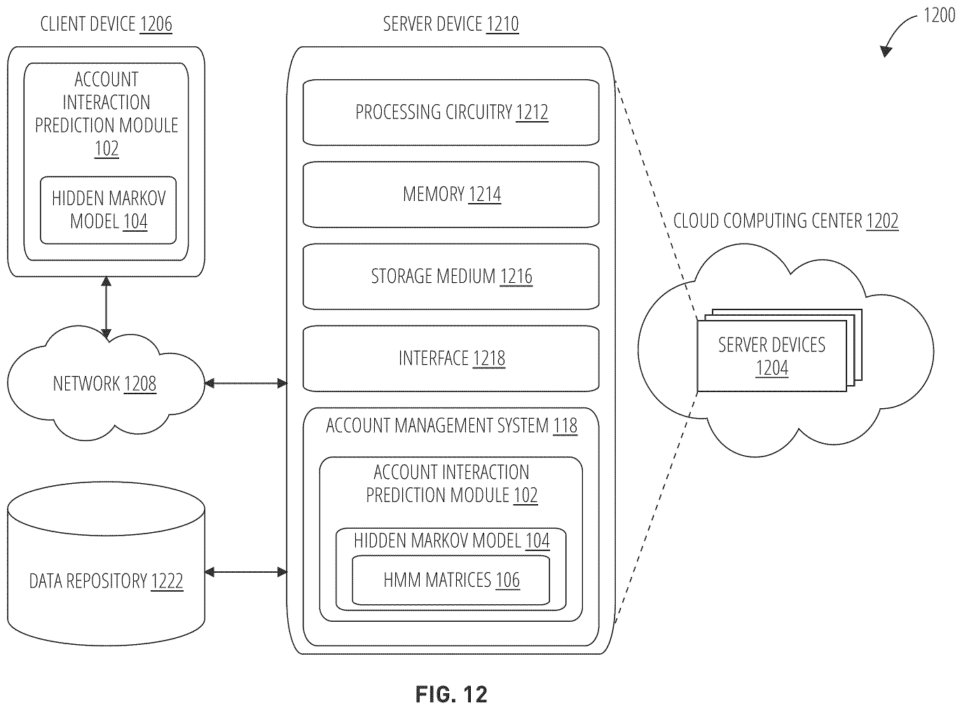

FIG. 12 illustrates an embodiment of a system 1200. The system 1200 is suitable for implementing one or more embodiments as described herein. In one embodiment, for example, the system 1200 is a system suitable for implementing the account interaction prediction module 102.

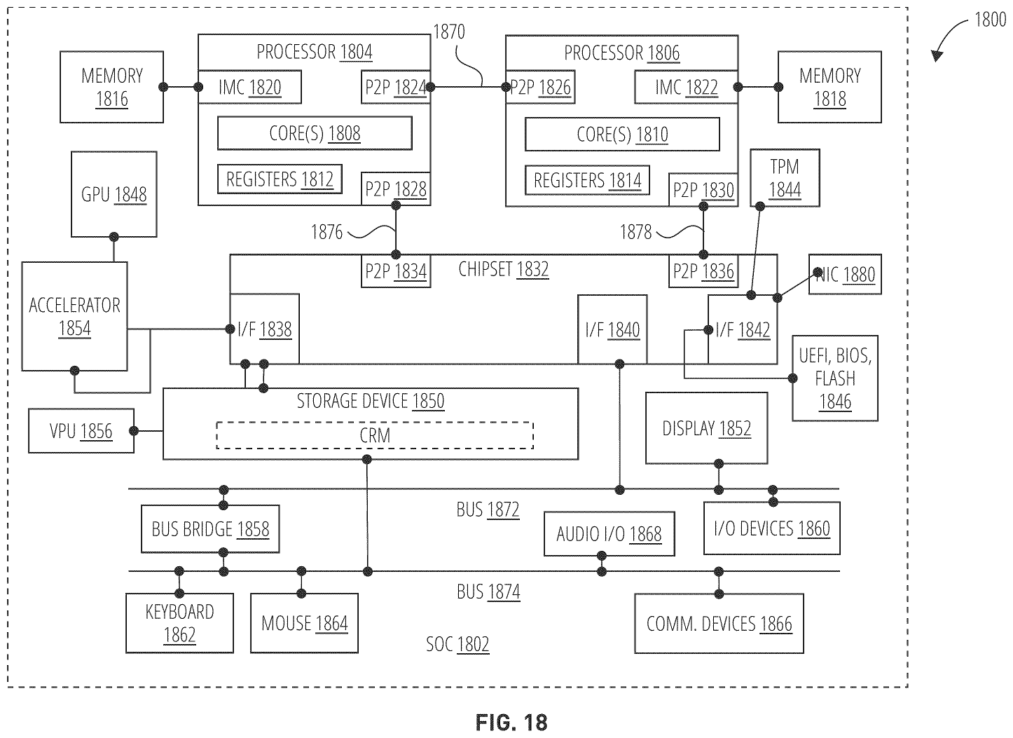

As depicted in FIG. 12, a set of server devices 1204 is implemented in a cloud computing center 1202. A representative server device 1210 communicates information with a client device 1206 over a network 1208. The server device 1210 includes processing circuitry 1212, a memory 1214, a storage medium 1216, an interface 1218, an account management system 1220, and the account interaction prediction module 102 implementing the hidden Markov model 104. In some implementations, the server device 1210 includes other components or devices as well, such as platform components. Examples for software elements and hardware elements of the server device 1210 are described in more detail with reference to a computing architecture 1800 as depicted in FIG. 18. Embodiments are not limited to these examples.

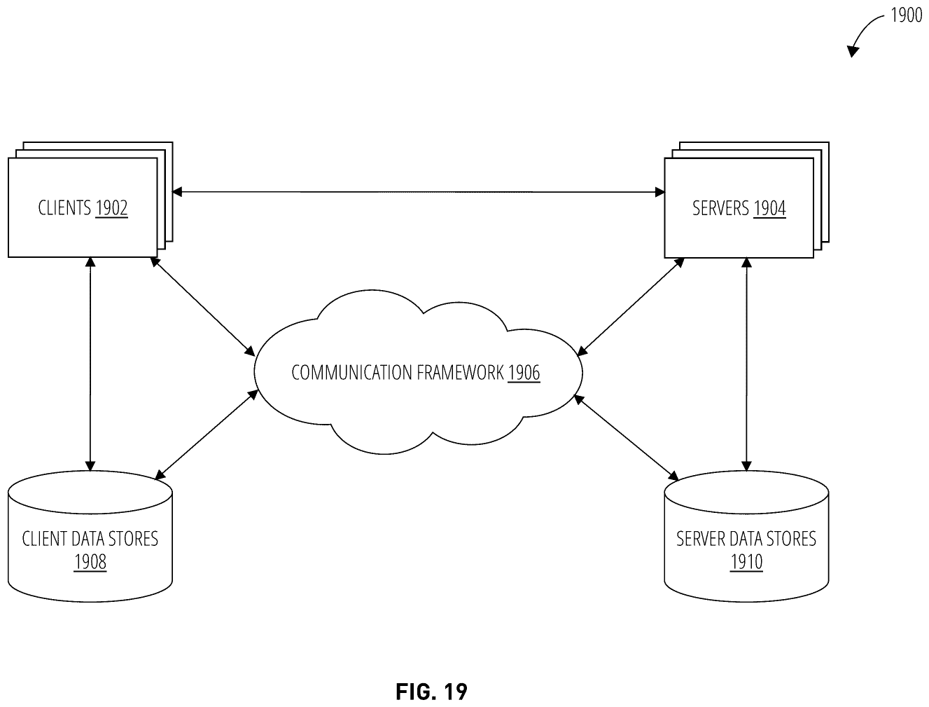

The server device 1210 is generally arranged to receive an input, process the input via one or more AI techniques, and send an output. The server device 1210 receives the input from the client device 1206 via the network 1208 or the account management system 118 (e.g., a touchscreen as a text command or microphone as a voice command), the memory 1214, the storage medium 1216 or the data repository 1222. The server device 1210 sends the output to the client device 1206 via the network 1208, the account management system 118 (e.g., a touchscreen to present text, graphic or video information or speaker to reproduce audio information), the memory 1214, the storage medium 1216 or the data repository 1222. Examples for the software elements and hardware elements of the network 1208 are described in more detail with reference to a communications architecture 1900 as depicted in FIG. 19. Embodiments are not limited to these examples.

The server device 1210 includes account management system 118 and an account interaction prediction module 102 to implement various AI techniques for various AI tasks. The account management system 118 receives the input, and processes the input using the account interaction prediction module 102. The account interaction prediction module 102 performs inferencing operations to generate an inference for a specific task from the input. In some cases, the inference is part of the output. The output is used by the client device 1206 or the server device 1210 to perform subsequent actions or downstream tasks in response to the output.

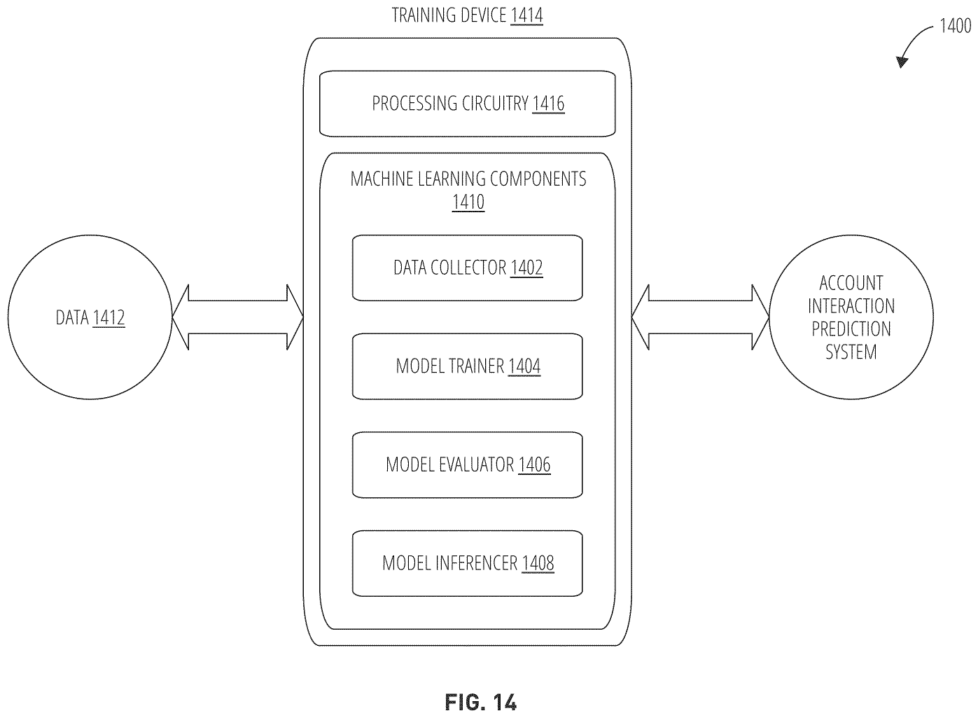

In various embodiments, the account interaction prediction module 102 is a trained account interaction prediction module 102 using a set of training operations. An example of training operations to train the account interaction prediction module 102 is described with reference to FIG. 14.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

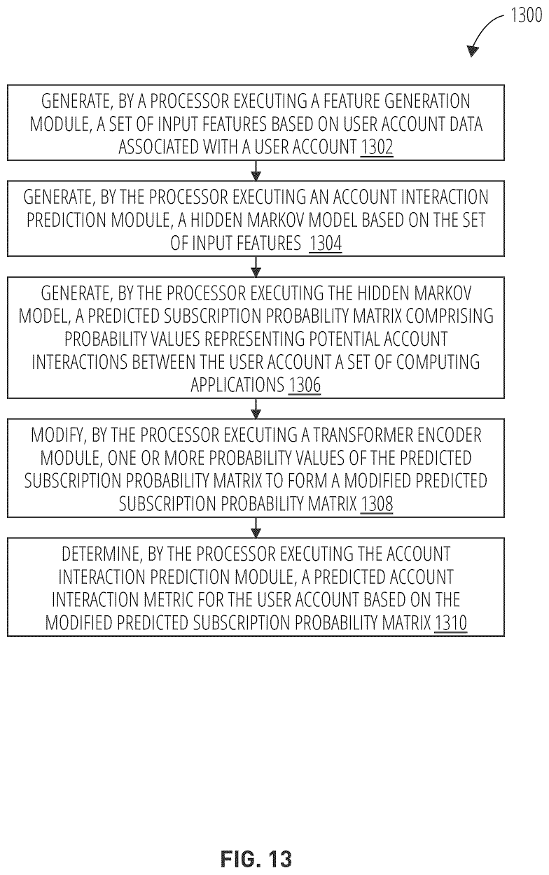

FIG. 13 illustrates an embodiment of a logic flow 1300. The logic flow 1300 is representative of some or all of the operations executed by one or more embodiments described herein. For example, the logic flow 1300 includes some or all of the operations performed by devices or entities within the account interaction prediction system 100. In one embodiment, the logic flow 1300 is implemented as instructions stored on a non-transitory computer-readable storage medium, such as the storage medium 1216, that when executed by the processing circuitry 1212 causes the processing circuitry 1212 to perform the described operations. The storage medium 1216 and processing circuitry 1212 may be co-located, or the instructions may be stored remotely from the processing circuitry 1212. Collectively, the storage medium 1216 and the processing circuitry 1212 may form a system.

In block 1302, logic flow 1300 generates, by a processing circuitry executing a feature generation module, a set of input features based on user account data associated with a user account. In block 1304, logic flow 1300 generates, by the processing circuitry executing an account interaction prediction module, a hidden Markov model based on the set of input features. In block 1306, logic flow 1300 generates, by the processing circuitry executing the hidden Markov model, a predicted subscription probability matrix comprising probability values representing potential account interactions between the user account a set of computing applications. In block 1308, logic flow 1300 modifies, by the processing circuitry executing a transformer encoder module, one or more probability values of the predicted subscription probability matrix to form a modified predicted subscription probability matrix. In block 1310, logic flow 1300 determines, by the processing circuitry executing the account interaction prediction module, a predicted account interaction metric for the user account based on the modified predicted subscription probability matrix.

By way of example, a processing circuitry 1212 executing a feature generation module 112 generates a set of input features 114 based on user account data 110 associated with a user account 108. The processing circuitry 1212 executing an account interaction prediction module 102 generates a hidden Markov model 104 based on the set of input features 114. The processing circuitry 1212 executing the hidden Markov model 104 generates a predicted subscription probability matrix 502 comprising probability values representing potential account interactions between the user account 108 a set of computing applications 122. The processing circuitry 1212 executing a transformer encoder module 926 modifies the one or more probability values of the predicted subscription probability matrix 502 to form a modified predicted subscription probability matrix 1120. The processing circuitry 1212 executing the account interaction prediction module 102 determines a predicted account interaction metric 116 for the user account 108 based on the modified predicted subscription probability matrix 1120.

In one embodiment, for example, the logic flow 1300 may also include where the predicted account interaction metric 116 includes a lifetime value (LTV) associated with the user account 108 over a defined time period.

In one embodiment, for example, the logic flow 1300 may also include concatenating, by the processing circuitry 1212 executing the transformer encoder module 926, the predicted subscription probability matrix 502 with a concatenated hidden states matrix 1110, generating, by the processing circuitry 1212 executing the transformer encoder module 926, a concatenated hidden states residual matrix 1112, adding, by the processing circuitry 1212 executing the transformer encoder module 926, the concatenated hidden states matrix 1110 and the concatenated hidden states residual matrix 1112 to form a modified concatenated hidden states matrix 1116, and multiplying, by the processing circuitry 1212 executing the transformer encoder module 926, the modified concatenated hidden states matrix 1116 and the emission matrix 220 to form the modified predicted subscription probability matrix 1120.

In one embodiment, for example, the logic flow 1300 may also include generating, by the processing circuitry 1212 executing a price mapper module 924, an initial price map 1004 that includes pricing values for a set of products or services provided by the set of computing applications 122, generating, by the processing circuitry 1212 executing the price mapper module 924, a set of price adjustments 1008 to the initial price map 1004 based on the set of input features 114, and modifying, by the processing circuitry 1212 executing the price mapper module 924, the initial price map 1004 to form a final price map 1010 for the user account 108 based on the initial price map 1004 and the set of price adjustments 1008.

In one embodiment, for example, the logic flow 1300 may also include generating, by the processing circuitry 1212 executing the account prediction interaction price mapper module 924, an initial state matrix 216 that includes a plurality of initial state values corresponding to the plurality of hidden states of the hidden Markov model 104 for the user account 108 based on the set of input features 114.

In one embodiment, for example, the logic flow 1300 may also include generating, by the processing circuitry 1212 executing the account prediction interaction price mapper module 924, the transition matrix 218 that includes a plurality of transition values corresponding to a plurality of hidden states of a hidden Markov model 104 for the user account 108 based on the set of input features 114.

In one embodiment, for example, the logic flow 1300 may also include generating, by the processing circuitry 1212 executing the account prediction interaction price mapper module 924, the emission matrix 220 that includes a plurality of emission values corresponding to the plurality of hidden states of the hidden Markov model 104 for the user account 108 based on the set of input features 114.

In one embodiment, for example, the logic flow 1300 may also include allocating, by the processing circuitry 1212 executing an account management system 118, a set of computing resources for the set of computing applications 122 based on the predicted account interaction metric 116. Other technical features may be readily apparent to one skilled in the art from the following figures, descriptions, and claims.

FIG. 14 illustrates an apparatus 1400. The apparatus 1400 depicts a training device 1414 suitable to generate a trained account interaction prediction module 102 for the server device 1210 of the system 1200. As depicted in FIG. 14, the training device 1414 includes a processing circuitry 1416 and a set of ML components 1410 to support various AI/ML techniques, such as a data collector 1402, a model trainer 1404, a model evaluator 1406 and a model inferencer 1408.

In general, the data collector 1402 collects data 1412 from one or more data sources to use as training data for the account interaction prediction module 102. The data collector 1402 collects different types of data 1412, such as text information, audio information, image information, video information, graphic information, and so forth. The model trainer 1404 receives as input the collected data and uses a portion of the collected data as test data for an AI/ML algorithm to train the account interaction prediction module 102. The model evaluator 1406 evaluates and improves the trained account interaction prediction module 102 using a portion of the collected data as test data to test the account interaction prediction module 102. The model evaluator 1406 also uses feedback information from the deployed account interaction prediction module 102. The model inferencer 1408 implements the trained account interaction prediction module 102 to receive as input new unseen data, generate one or more inferences on the new data, and output a result such as an alert, a recommendation or other post-solution activity.

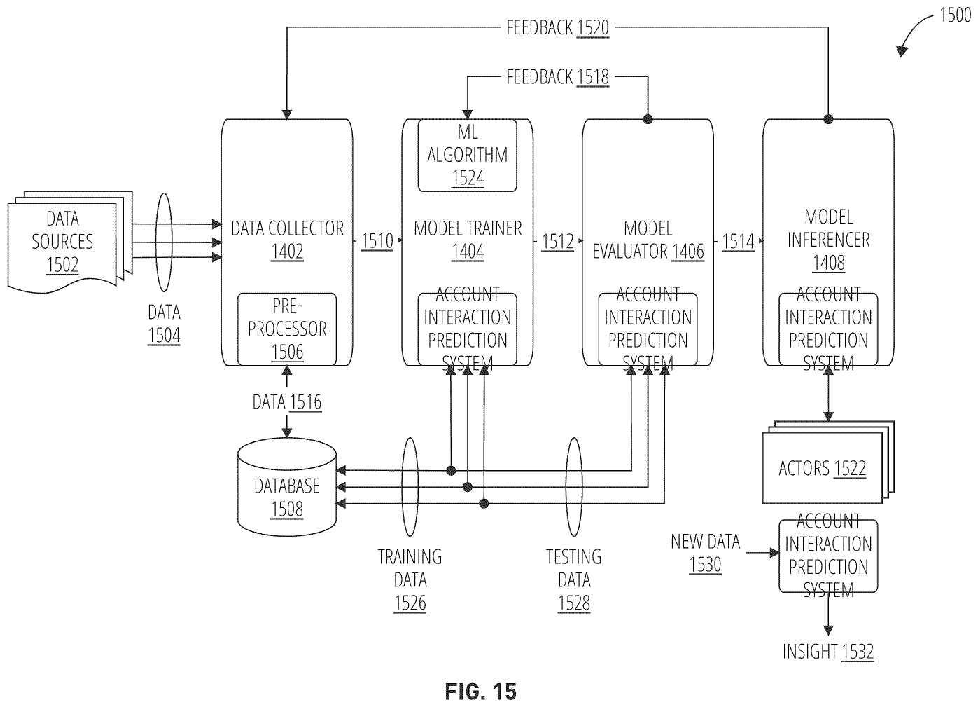

An exemplary AI/ML architecture for the ML components 1410 is described in more detail with reference to FIG. 15.

FIG. 15 illustrates an artificial intelligence architecture 1500 suitable for use by the training device 1414 to generate the hidden Markov model 104 of the account interaction prediction module 102 for deployment by the server device 1210. The artificial intelligence architecture 1500 is an example of a system suitable for implementing various AI techniques and/or ML techniques to perform various inferencing tasks on behalf of the various devices of the system 1200.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1500 includes various machine or computer components (e.g., circuit, processor circuit, memory, network interfaces, compute platforms, input/output (I/O) devices, etc.) for an AI/ML system that are designed to work together to create a pipeline that can take in raw data, process it, train a hidden Markov model 104, evaluate performance of the trained hidden Markov model 104, and deploy the tested hidden Markov model 104 as the trained hidden Markov model 104 in a production environment, and continuously monitor and maintain it.

The hidden Markov model 104 is a mathematical construct used to predict outcomes based on a set of input data. The hidden Markov model 104 is trained using large volumes of training data 1526, and it can recognize patterns and trends in the training data 1526 to make accurate predictions. The hidden Markov model 104 is derived from an ML algorithm 1524 (e.g., a neural network, decision tree, support vector machine, etc.). A data set is fed into the ML algorithm 1524 which trains a hidden Markov model 104 to “learn” a function that produces mappings between a set of inputs and a set of outputs with a reasonably high accuracy. Given a sufficiently large enough set of inputs and outputs, the ML algorithm 1524 finds the function for a given task. This function may even be able to produce the correct output for input that it has not seen during training. A data scientist prepares the mappings, selects and tunes the ML algorithm 1524, and evaluates the resulting model performance. Once the hidden Markov model 104 is sufficiently accurate on test data, it can be deployed for production use.

The ML algorithm 1524 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1524 of the artificial intelligence architecture 1500 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 15, the artificial intelligence architecture 1500 includes a set of data sources 1502 to source data 1504 for the artificial intelligence architecture 1500. Data sources 1502 may comprise any device capable generating, processing, storing or managing data 1504 suitable for a ML system. Examples of data sources 1502 include without limitation databases, web scraping, sensors and Internet of Things (IoT) devices, image and video cameras, audio devices, text generators, publicly available databases, private databases, and many other data sources 1502. The data sources 1502 may be remote from the artificial intelligence architecture 1500 and accessed via a network, local to the artificial intelligence architecture 1500 an accessed via a network interface, or may be a combination of local and remote data sources 1502.

The data sources 1502 source difference types of data 1504. By way of example and not limitation, the data 1504 includes structured data from relational databases, such as customer profiles, transaction histories, or product inventories. The data 1504 includes unstructured data from websites such as customer reviews, news articles, social media posts, or product specifications. The data 1504 includes data from temperature sensors, motion detectors, and smart home appliances. The data 1504 includes image data from medical images, security footage, or satellite images. The data 1504 includes audio data from speech recognition, music recognition, or call centers. The data 1504 includes text data from emails, chat logs, customer feedback, news articles or social media posts. The data 1504 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1504 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1502 are communicatively coupled to a data collector 1402. The data collector 1402 gathers relevant data 1504 from the data sources 1502. Once collected, the data collector 1402 may use a pre-processor 1506 to make the data 1504 suitable for analysis. This involves data cleaning, transformation, and feature engineering. Data preprocessing is a critical step in ML as it directly impacts the accuracy and effectiveness of the hidden Markov model 104. The pre-processor 1506 receives the data 1504 as input, processes the data 1504, and outputs pre-processed data 1516 for storage in a database 1508. Examples for the database 1508 includes a hard drive, solid state storage, and/or random access memory (RAM).

The data collector 1402 is communicatively coupled to a model trainer 1404. The model trainer 1404 performs AI/ML model training, validation, and testing which may generate model performance metrics as part of the model testing procedure. The model trainer 1404 receives the pre-processed data 1516 as input 1510 or via the database 1508. The model trainer 1404 implements a suitable ML algorithm 1524 to train a hidden Markov model 104 on a set of training data 1526 from the pre-processed data 1516. The training process involves feeding the pre-processed data 1516 into the ML algorithm 1524 to produce or optimize a hidden Markov model 104. The training process adjusts its parameters until it achieves an initial level of satisfactory performance.

The model trainer 1404 is communicatively coupled to a model evaluator 1406. After a hidden Markov model 104 is trained, the hidden Markov model 104 needs to be evaluated to assess its performance. This is done using various metrics such as accuracy, precision, recall, and F1 score. The model trainer 1404 outputs the hidden Markov model 104, which is received as input 1510 or from the database 1508. The model evaluator 1406 receives the hidden Markov model 104 as input 1512, and it initiates an evaluation process to measure performance of the hidden Markov model 104. The evaluation process includes providing feedback 1518 to the model trainer 1404. The model trainer 1404 re-trains the hidden Markov model 104 to improve performance in an iterative manner.

The model evaluator 1406 is communicatively coupled to a model inferencer 1408. The model inferencer 1408 provides AI/ML model inference output (e.g., inferences, predictions or decisions). Once the hidden Markov model 104 is trained and evaluated, it is deployed in a production environment where it is used to make predictions on new data. The model inferencer 1408 receives the evaluated hidden Markov model 104 as input 1514. The model inferencer 1408 uses the evaluated hidden Markov model 104 to produce insights or predictions on real data, which is deployed as a final production hidden Markov model 104. The inference output of the hidden Markov model 104 is use case specific. The model inferencer 1408 also performs model monitoring and maintenance, which involves continuously monitoring performance of the hidden Markov model 104 in the production environment and making any necessary updates or modifications to maintain its accuracy and effectiveness. The model inferencer 1408 provides feedback 1518 to the data collector 1402 to train or re-train the hidden Markov model 104. The feedback 1518 includes model performance feedback information, which is used for monitoring and improving performance of the hidden Markov model 104.

Some or all of the model inferencer 1408 is implemented by various actors 1522 in the artificial intelligence architecture 1500, including the hidden Markov model 104 of the server device 1210, for example. The actors 1522 use the deployed hidden Markov model 104 on new data to make inferences or predictions for a given task, and output an insight 1532. The actors 1522 implement the model inferencer 1408 locally, or remotely receives outputs from the model inferencer 1408 in a distributed computing manner. The actors 1522 trigger actions directed to other entities or to itself. The actors 1522 provide feedback 1520 to the data collector 1402 via the model inferencer 1408. The feedback 1520 comprise data needed to derive training data, inference data or to monitor the performance of the hidden Markov model 104 and its impact to the network through updating of key performance indicators (KPIs) and performance counters.

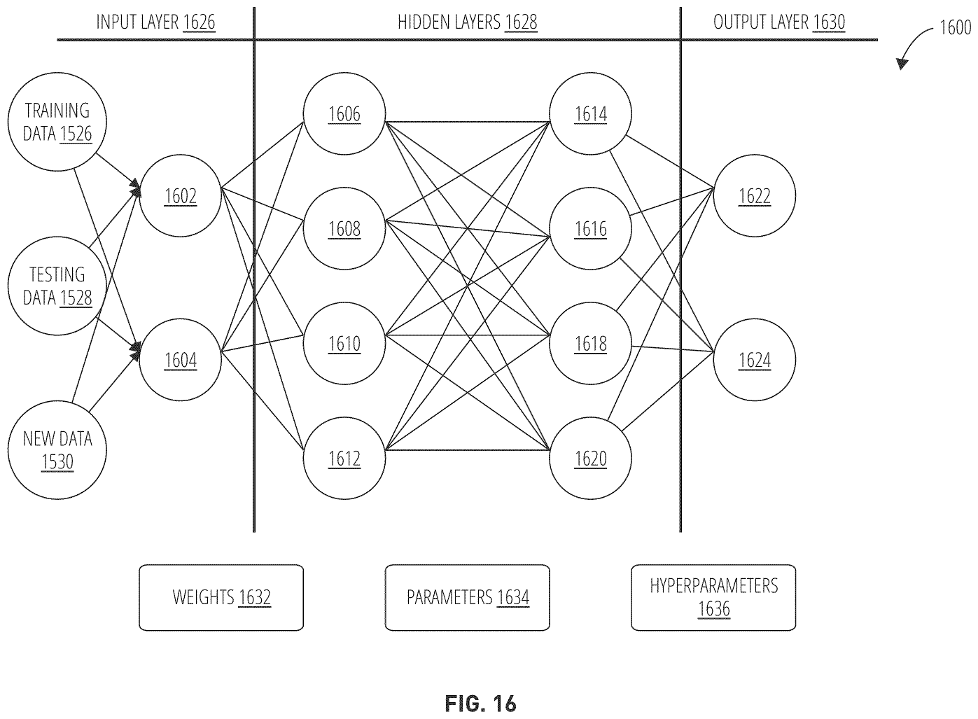

As previously described with reference to FIGS. 1, 2, the systems 1200, 1400 implement some or all of the artificial intelligence architecture 1500 to support various use cases and solutions for various AI/ML tasks. In various embodiments, the training device 1414 of the apparatus 1400 uses the artificial intelligence architecture 1500 to generate and train the hidden Markov model 104 for use by the server device 1210 for the system 1200. In one embodiment, for example, the training device 1414 may train the hidden Markov model 104 as a neural network, as described in more detail with reference to FIG. 16. Other use cases and solutions for AI/ML are possible as well, and embodiments are not limited in this context.

FIG. 16 illustrates an embodiment of an artificial neural network 1600. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1600 comprises multiple node layers, containing an input layer 1626, one or more hidden layers 1628, and an output layer 1630. Each layer comprises one or more nodes, such as nodes 1602 to 1624. As depicted in FIG. 16, for example, the input layer 1626 has nodes 1602, 1604. The artificial neural network 1600 has two hidden layers 1628, with a first hidden layer having nodes 1606, 1608, 1610 and 1612, and a second hidden layer having nodes 1614, 1616, 1618 and 1620. The artificial neural network 1600 has an output layer 1630 with nodes 1622, 1624. Each node 1602 to 1624 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1600 relies on training data 1526 to learn and improve accuracy over time. However, once the artificial neural network 1600 is fine-tuned for accuracy, and tested on testing data 1528, the artificial neural network 1600 is ready to classify and cluster new data 1530 at a high velocity. Note the training data 1526, the testing data 1528, and the new data 1530 are fed into the input layer nodes 1602 and 1604 at different times for different purposes. Tasks in speech recognition or image recognition can take minutes versus hours when compared to the manual identification by human experts.

Each individual node 1602 to 1624 is a linear regression model, composed of input data, weights, a bias (or threshold), and an output. Once an input layer 1626 is determined, a set of weights 1632 are assigned. The weights 1632 help determine the importance of any given variable, with larger ones contributing more significantly to the output compared to other inputs. All inputs are then multiplied by their respective weights and then summed.

Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1600 as a feedforward network.

In one embodiment, the artificial neural network 1600 leverages sigmoid neurons, which are distinguished by having values between 0 and 1. Since the artificial neural network 1600 behaves similarly to a decision tree, cascading data from one node to another, having x values between 0 and 1 will reduce the impact of any given change of a single variable on the output of any given node, and subsequently, the output of the artificial neural network 1600.

The artificial neural network 1600 has many practical use cases, like image recognition, speech recognition, text recognition or classification. The artificial neural network 1600 leverages supervised learning, or labeled datasets, to train the algorithm. As the model is trained, its accuracy is measured using a cost (or loss) function. This is also commonly referred to as the mean squared error (MSE).

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1634 of the model adjust to gradually converge at the minimum.

In one embodiment, the artificial neural network 1600 is feedforward, meaning it flows in one direction only, from input to output. In one embodiment, the artificial neural network 1600 uses backpropagation. Backpropagation is when the artificial neural network 1600 moves in the opposite direction from output to input. Backpropagation allows calculation and attribution of errors associated with each neuron 1602 to 1624, thereby allowing adjustment to fit the parameters 1634 of the hidden Markov model 104 appropriately.

The artificial neural network 1600 is implemented as different neural networks depending on a given task. Neural networks are classified into different types, which are used for different purposes. In one embodiment, the artificial neural network 1600 is implemented as a feedforward neural network, or multi-layer perceptrons (MLPs), comprised of an input layer 1626, hidden layers 1628, and an output layer 1630. While these neural networks are also commonly referred to as MLPs, they are actually comprised of sigmoid neurons, not perceptrons, as most real-world problems are nonlinear. Trained data 1504 usually is fed into these models to train them, and they are the foundation for computer vision, natural language processing, and other neural networks. In one embodiment, the artificial neural network 1600 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1600 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1600 is implemented as any type of neural network suitable for a given operational task of system 1200, and the MLP, CNN, and RNN are merely a few examples. Embodiments are not limited in this context.

The artificial neural network 1600 includes a set of associated parameters 1634. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1600 is implemented as a deep learning neural network. The term deep learning neural network refers to a depth of layers in a given neural network. A neural network that has more than three layers-which would be inclusive of the inputs and the output—can be considered a deep learning algorithm. A neural network that only has two or three layers, however, may be referred to as a basic neural network. A deep learning neural network may tune and optimize one or more hyperparameters 1636. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

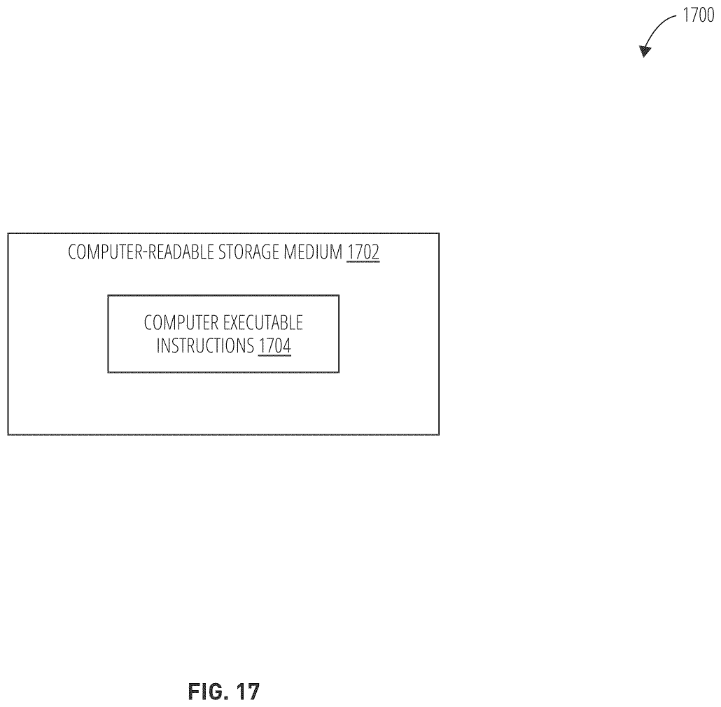

FIG. 17 illustrates an apparatus 1700. Apparatus 1700 comprises any non-transitory computer-readable storage medium 1702 or machine-readable storage medium, such as an optical, magnetic or semiconductor storage medium. In various embodiments, apparatus 1700 comprises an article of manufacture or a product. In some embodiments, the computer-readable storage medium 1702 stores computer executable instructions with which one or more processing devices or processing circuitry can execute. For example, computer executable instructions 1704 includes instructions to implement operations described with respect to any logic flows described herein. Examples of computer-readable storage medium 1702 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1704 include any suitable type of code, such as source code, compiled code, interpreted code, executable code, static code, dynamic code, object-oriented code, visual code, and the like.

FIG. 18 illustrates an embodiment of a computing architecture 1800. Computing architecture 1800 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1800 has a single processor with one core or more than one processor. Note that the term “processor” refers to a processor with a single core or a processor package with multiple processor cores. In at least one embodiment, the computing architecture 1800 is representative of the components of the system 1200. More generally, the computing architecture 1800 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1800. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 18, computing architecture 1800 comprises a system-on-chip (SoC) 1802 for mounting platform components. System-on-chip (SoC) 1802 is a point-to-point (P2P) interconnect platform that includes a first processor 1804 and a second processor 1806 coupled via a point-to-point interconnect 1870 such as an Ultra Path Interconnect (UPI). In other embodiments, the computing architecture 1800 is another bus architecture, such as a multi-drop bus. Furthermore, each of processor 1804 and processor 1806 are processor packages with multiple processor cores including core(s) 1808 and core(s) 1810, respectively. While the computing architecture 1800 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1804 and chipset 1832. Some platforms include additional components and some platforms include sockets to mount the processors and/or the chipset. Furthermore, some platforms do not have sockets (e.g. SoC, or the like). Although depicted as a SoC 1802, one or more of the components of the SoC 1802 are included in a single die package, a multi-chip module (MCM), a multi-die package, a chiplet, a bridge, and/or an interposer. Therefore, embodiments are not limited to a SoC.

The processor 1804 and processor 1806 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1804 and/or processor 1806. Additionally, the processor 1804 need not be identical to processor 1806.

Processor 1804 includes an integrated memory controller (IMC) 1820 and point-to-point (P2P) interface 1824 and P2P interface 1828. Similarly, the processor 1806 includes an IMC 1822 as well as P2P interface 1826 and P2P interface 1830. IMC 1820 and IMC 1822 couple the processor 1804 and processor 1806, respectively, to respective memories (e.g., memory 1816 and memory 1818). Memory 1816 and memory 1818 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1816 and the memory 1818 locally attach to the respective processors (i.e., processor 1804 and processor 1806). In other embodiments, the main memory couple with the processors via a bus and shared memory hub. Processor 1804 includes registers 1812 and processor 1806 includes registers 1814.

Computing architecture 1800 includes chipset 1832 coupled to processor 1804 and processor 1806. Furthermore, chipset 1832 are coupled to storage device 1850, for example, via an interface (I/F) 1838. The I/F 1838 may be, for example, a Peripheral Component Interconnect-enhanced (PCIe) interface, a Compute Express Link® (CXL) interface, or a Universal Chiplet Interconnect Express (UCIe) interface. Storage device 1850 stores instructions executable by circuitry of computing architecture 1800 (e.g., processor 1804, processor 1806, GPU 1848, accelerator 1854, vision processing unit 1856, or the like). For example, storage device 1850 can store instructions for the client device 1206, the server device 1210, the training device 1414, or the like.

Processor 1804 couples to the chipset 1832 via P2P interface 1828 and P2P 1834 while processor 1806 couples to the chipset 1832 via P2P interface 1830 and P2P 1836. Direct media interface (DMI) 1876 and DMI 1878 couple the P2P interface 1828 and the P2P 1834 and the P2P interface 1830 and P2P 1836, respectively. DMI 1876 and DMI 1878 is a high-speed interconnect that facilitates, e.g., eight Giga Transfers per second (GT/s) such as DMI 3.0. In other embodiments, the processor 1804 and processor 1806 interconnect via a bus.

The chipset 1832 comprises a controller hub such as a platform controller hub (PCH). The chipset 1832 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1832 comprises more than one controller hub such as a chipset with a memory controller hub, a graphics controller hub, and an input/output (I/O) controller hub.

In the depicted example, chipset 1832 couples with a trusted platform module (TPM) 1844 and UEFI, BIOS, FLASH circuitry 1846 via I/F 1842. The TPM 1844 is a dedicated microcontroller designed to secure hardware by integrating cryptographic keys into devices. The UEFI, BIOS, FLASH circuitry 1846 may provide pre-boot code. The I/F 1842 may also be coupled to a network interface circuit (NIC) 1880 for connections off-chip.

Furthermore, chipset 1832 includes the I/F 1838 to couple chipset 1832 with a high-performance graphics engine, such as, graphics processing circuitry or a graphics processing unit (GPU) 1848. In other embodiments, the computing architecture 1800 includes a flexible display interface (FDI) (not shown) between the processor 1804 and/or the processor 1806 and the chipset 1832. The FDI interconnects a graphics processor core in one or more of processor 1804 and/or processor 1806 with the chipset 1832.

The computing architecture 1800 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1854 and/or vision processing unit 1856 are coupled to chipset 1832 via I/F 1838. The accelerator 1854 is representative of any type of accelerator device (e.g., a data streaming accelerator, cryptographic accelerator, cryptographic co-processor, an offload engine, etc.). One example of an accelerator 1854 is the Intel® Data Streaming Accelerator (DSA). The accelerator 1854 is a device including circuitry to accelerate copy operations, data encryption, hash value computation, data comparison operations (including comparison of data in memory 1816 and/or memory 1818), and/or data compression. Examples for the accelerator 1854 include a USB device, PCI device, PCIe device, CXL device, UCIe device, and/or an SPI device. The accelerator 1854 also includes circuitry arranged to execute machine learning (ML) related operations (e.g., training, inference, etc.) for ML models. Generally, the accelerator 1854 is specially designed to perform computationally intensive operations, such as hash value computations, comparison operations, cryptographic operations, and/or compression operations, in a manner that is more efficient than when performed by the processor 1804 or processor 1806. Because the load of the computing architecture 1800 includes hash value computations, comparison operations, cryptographic operations, and/or compression operations, the accelerator 1854 greatly increases performance of the computing architecture 1800 for these operations.

The accelerator 1854 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1854. For example, the accelerator 1854 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1854 via a non-posted write (e.g., a deferred memory write (DMWr)). One example of an instruction that atomically submits a work descriptor to the shared work queue of the accelerator 1854 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1854. The dedicated work queue may accept job submissions via commands such as the movdir64b instruction.

Various I/O devices 1860 and display 1852 couple to the bus 1872, along with a bus bridge 1858 which couples the bus 1872 to a second bus 1874 and an I/F 1840 that connects the bus 1872 with the chipset 1832. In one embodiment, the second bus 1874 is a low pin count (LPC) bus. Various input/output (I/O) devices couple to the second bus 1874 including, for example, a keyboard 1862, a mouse 1864 and communication devices 1866.

Furthermore, an audio I/O 1868 couples to second bus 1874. Many of the I/O devices 1860 and communication devices 1866 reside on the system-on-chip (SoC) 1802 while the keyboard 1862 and the mouse 1864 are add-on peripherals. In other embodiments, some or all the I/O devices 1860 and communication devices 1866 are add-on peripherals and do not reside on the system-on-chip (SoC) 1802.

FIG. 19 illustrates a block diagram of an exemplary communications architecture 1900 suitable for implementing various embodiments as previously described. The communications architecture 1900 includes various common communications elements, such as a transmitter, receiver, transceiver, radio, network interface, baseband processor, antenna, amplifiers, filters, power supplies, and so forth. The embodiments, however, are not limited to implementation by the communications architecture 1900.

As shown in FIG. 19, the communications architecture 1900 includes one or more clients 1902 and servers 1904. The clients 1902 and the servers 1904 are operatively connected to one or more respective client data stores 1908 and server data stores 1910 that can be employed to store information local to the respective clients 1902 and servers 1904, such as cookies and/or associated contextual information.

The clients 1902 and the servers 1904 communicate information between each other using a communication framework 1906. The communication framework 1906 implements any well-known communications techniques and protocols. The communication framework 1906 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1906 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/1200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1902 and the servers 1904. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What is claimed is:

1. A system, comprising:
a memory component; and
one or more processing devices coupled to the memory component, the one or more processing devices to perform operations comprising:
generating a set of input features based on user account data associated with a user account;
generating a hidden Markov model based on the set of input features;
generating a predicted subscription probability matrix comprising probability values representing potential account interactions between the user account a set of computing applications;
modifying one or more probability values of the predicted subscription probability matrix to form a modified predicted subscription probability matrix; and
determining a predicted account interaction metric for the user account based on the modified predicted subscription probability matrix.

2. The system of claim 1, wherein the predicted account interaction metric comprises a lifetime value (LTV) associated with the user account over a defined time period.

3. The system of claim 1, the one or more processing devices to perform operations comprising:
concatenating the predicted subscription probability matrix with a concatenated hidden states matrix;
generating a concatenated hidden states residual matrix;
adding the concatenated hidden states matrix and the concatenated hidden states residual matrix to form a modified concatenated hidden states matrix; and
multiplying the modified concatenated hidden states matrix and an emission matrix to form the modified predicted subscription probability matrix.

4. The system of claim 1, the one or more processing devices to perform operations comprising:
generating an initial price map comprising pricing values for a set of products or services provided by the set of computing applications;
generating a set of price adjustments to the initial price map based on the set of input features; and
modifying the initial price map to form a final price map for the user account based on the initial price map and the set of price adjustments.

5. The system of claim 1, the one or more processing devices to perform operations comprising generating an initial state matrix comprising a plurality of initial state values corresponding to the plurality of hidden states of the hidden Markov model for the user account based on the set of input features.

6. The system of claim 1, the one or more processing devices to perform operations comprising generating a transition matrix comprising a plurality of transition values corresponding to a plurality of hidden states of a hidden Markov model for the user account based on the set of input features.

7. The system of claim 1, the one or more processing devices to perform operations comprising generating an emission matrix comprising a plurality of emission values corresponding to the plurality of hidden states of the hidden Markov model for the user account based on the set of input features.

8. The system of claim 1, the one or more processing devices to perform operations comprising allocating a set of computing resources for the set of computing applications based on the predicted account interaction metric.

9. A method, comprising:
generating, by processing circuitry executing a feature generation module, a set of input features based on user account data associated with a user account;
generating, by the processing circuitry executing an account interaction prediction module, a hidden Markov model based on the set of input features, the hidden Markov model comprising an initial state matrix, a transition matrix, and an emission matrix;
generating, by the processing circuitry executing the hidden Markov model, a predicted subscription probability matrix comprising probability values representing potential account interactions between the user account a set of computing applications;
modifying, by the processing circuitry executing a transformer encoder module, one or more probability values of the predicted subscription probability matrix to form a modified predicted subscription probability matrix; and
determining, by the processing circuitry executing the account interaction prediction module, a predicted account interaction metric for the user account based on the modified predicted subscription probability matrix.

10. The method of claim 9, wherein the predicted account interaction metric comprises a lifetime value (LTV) associated with the user account over a defined time period.

11. The method of claim 9, comprising:
concatenating, by the processing circuitry executing the transformer encoder module, the predicted subscription probability matrix with a concatenated hidden states matrix;
generating, by the processing circuitry executing the transformer encoder module, a concatenated hidden states residual matrix;
adding, by the processing circuitry executing the transformer encoder module, the concatenated hidden states matrix and the concatenated hidden states residual matrix to form a modified concatenated hidden states matrix; and
multiplying, by the processing circuitry executing the transformer encoder module, the modified concatenated hidden states matrix and the emission matrix to form the modified predicted subscription probability matrix.

12. The method of claim 9, comprising:
generating, by the processing circuitry executing a price mapper module, an initial price map comprising pricing values for a set of products or services provided by the set of computing applications;
generating, by the processing circuitry executing the price mapper module, a set of price adjustments to the initial price map based on the set of input features; and
modifying, by the processing circuitry executing the price mapper module, the initial price map to form a final price map for the user account based on the initial price map and the set of price adjustments.

13. The method of claim 9, comprising generating, by the processing circuitry executing the account prediction interaction module, the initial state matrix comprising a plurality of initial state values corresponding to the plurality of hidden states of the hidden Markov model for the user account based on the set of input features.

14. The method of claim 9, comprising generating, by the processing circuitry executing the account prediction interaction module, the transition matrix comprising a plurality of transition values corresponding to a plurality of hidden states of a hidden Markov model for the user account based on the set of input features.

15. The method of claim 9, comprising generating, by the processing circuitry executing the account prediction interaction module, the emission matrix comprising a plurality of emission values corresponding to the plurality of hidden states of the hidden Markov model for the user account based on the set of input features.

16. A non-transitory computer-readable medium storing executable instructions, which when executed by one or more processing devices, cause the one or more processing devices to perform operations comprising:
generating a set of input features based on user account data associated with a user account;
generating a hidden Markov model based on the set of input features;
generating a predicted subscription probability matrix comprising probability values representing potential account interactions between the user account a set of computing applications;
modifying one or more probability values of the predicted subscription probability matrix to form a modified predicted subscription probability matrix; and
determining a predicted account interaction metric for the user account based on the modified predicted subscription probability matrix.

17. The computer-readable medium of claim 16, wherein the predicted account interaction metric comprises a lifetime value (LTV) associated with the user account over a defined time period.

18. The computer-readable medium of claim 16 storing executable instructions, which when executed by the one or more processing devices, cause the one or more processing devices to perform operations comprising:
concatenating the predicted subscription probability matrix with a concatenated hidden states matrix;
generating a concatenated hidden states residual matrix;
adding the concatenated hidden states matrix and the concatenated hidden states residual matrix to form a modified concatenated hidden states matrix; and
multiplying the modified concatenated hidden states matrix and an emission matrix to form the modified predicted subscription probability matrix.

19. The computer-readable medium of claim 16 storing executable instructions, which when executed by the one or more processing devices, cause the one or more processing devices to perform operations comprising:
generating an initial price map comprising pricing values for a set of products or services provided by the set of computing applications;
generating a set of price adjustments to the initial price map based on the set of input features; and
modifying the initial price map to form a final price map for the user account based on the initial price map and the set of price adjustments.

20. The computer-readable medium of claim 16 storing executable instructions, which when executed by the one or more processing devices, cause the one or more processing devices to perform operations comprising allocating a set of computing resources for the set of computing applications based on the predicted account interaction metric.
